(19) United States
(12) Patent Application Publication
(10) Pub. No.: US 2007/0209069 A1
(43) Pub. Date: Sep. 6, 2007

(54) PUSH-TO-ASK PROTOCOL LAYER PROVISIONING AND USAGE METHOD

(75) Inventors: Samir Dilipkumar Saklikar, Mumbai (IN); Nilanjan Banerjee, Calcutta (IN); Subir Saha, Bangalore (IN)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/681,005

(22) Filed: Mar. 1, 2007

(30) Foreign Application Priority Data
Mar. 3, 2006 (IN) 561/DEL/2006

(51) Int. Cl. G06F 15/16

(52) U.S. Cl. 726/14

(57) ABSTRACT

Generally speaking, pursuant to these various embodiments, one provides (101) a push-to-ask protocol layer that comprises, at least in part, a question receiving function, an answer receiving function, a trust management function, and a propagation function. By one approach this propagation function is configured and arranged to determine the propagation of content as a function, at least in part, of trust information as is provided by the trust management function. This content can comprise, for example, at least one of a question as is provided by the question receiving function and/or an answer as is provided by the answer receiving function. This push-to-ask protocol layer may then be used (102) to facilitate the automated dissemination of a question as may be provided via a push-to-ask application to, for example, a social network as corresponds to a user of that push-to-ask application and to facilitate a return of at least one corresponding answer to that push-to-ask application.

### TECHNICAL FIELD

This invention relates generally to communication protocol layers.

### BACKGROUND

Communication protocol layers of various kinds are known in the art and many more continue to be further extended or newly introduced on a regular basis. Such layers typically serve, at least in part, to facilitate connectivity. This, in turn, often facilitates the establishment and maintenance of communication paths and/or mechanisms that permit the exchange of end user messages and content between two or more network entities. Current examples include, but are not limited to, email and instant messaging. As a result, relatively ubiquitous communications access via an ever-expanding number of end-user platforms is become a reality for an ever-growing number of people.

Such increased accessibility, at least in part, likely plays an important part in a corresponding growth in the demand for useful content by many end users. Unfortunately, while increased connectivity options and availability has indeed significantly increased the sheer quantity of information that a given end user may access at any given time or place, such a development has not also always led to the availability of genuinely useful information.

Or, perhaps more accurately, such developments often do not permit a given end user to know “good” information when they receive it. Instead, useful information is also often presented in sum and substance with a large quantity of other information. Such other information can range from being merely irrelevant to being inaccurate or even maliciously intended.

### BRIEF DESCRIPTION OF THE DRAWINGS

The above needs are at least partially met through provision of the push-to-ask protocol layer provisioning and usage method described in the following detailed description, particularly when studied in conjunction with the drawings, wherein:

FIG. 1 comprises a flow diagram as configured in accordance with various embodiments of the invention;

FIG. 2 comprises a schematic block diagram view as configured in accordance with various embodiments of the invention;

FIG. 3 comprises a flow diagram as configured in accordance with various embodiments of the invention;

FIG. 4 comprises a flow diagram as configured in accordance with various embodiments of the invention;

FIG. 5 comprises a schematic block diagram view as configured in accordance with various embodiments of the invention;

FIG. 6 comprises a block diagram view as configured in accordance with various embodiments of the invention;

FIG. 7 comprises a Venn diagram as configured in accordance with various embodiments of the invention;

FIG. 8 comprises a schematic view as configured in accordance with various embodiments of the invention;

FIG. 9 comprises a schematic view as configured in accordance with various embodiments of the invention;

FIG. 10 comprises a block diagram view as configured in accordance with various embodiments of the invention;

FIG. 11 comprises a block diagram view as configured in accordance with various embodiments of the invention;

FIG. 12 comprises a block diagram view as configured in accordance with various embodiments of the invention;

FIG. 13 comprises a block diagram view as configured in accordance with various embodiments of the invention;

FIG. 14 comprises a block diagram view as configured in accordance with various embodiments of the invention;

FIG. 15 comprises a block diagram view as configured in accordance with various embodiments of the invention;

FIG. 16 comprises a block diagram view as configured in accordance with various embodiments of the invention;

FIG. 17 comprises a schematic block diagram view as configured in accordance with various embodiments of the invention;

FIG. 18 comprises a flow diagram as configured in accordance with various embodiments of the invention;

FIG. 19 comprises a flow diagram as configured in accordance with various embodiments of the invention;

FIG. 20 comprises a flow diagram as configured in accordance with various embodiments of the invention;

FIG. 21 comprises a block diagram as configured in accordance with various embodiments of the invention;

FIG. 22 comprises a flow diagram as configured in accordance with various embodiments of the invention;

FIG. 23 comprises a flow diagram as configured in accordance with various embodiments of the invention;

FIG. 24 comprises a flow diagram as configured in accordance with various embodiments of the invention;

FIG. 25 comprises a flow diagram as configured in accordance with various embodiments of the invention;

FIG. 26 comprises a schematic block diagram view as configured in accordance with various embodiments of the invention;

FIG. 27 comprises a call flow diagram as configured in accordance with various embodiments of the invention;

FIG. 28 comprises a call flow diagram as configured in accordance with various embodiments of the invention;

FIG. 29 comprises a call flow diagram as configured in accordance with various embodiments of the invention; and

FIG. 30 comprises a call flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, one provides a push-to-ask protocol layer that comprises, at least in part, a question receiving function, an answer receiving function, a trust management function, and a propagation function. By one approach this propagation function is configured and arranged to determine the propagation of content as a function, at least in part, of trust information as is provided by the trust management function. This content can comprise, for example, at least one of a question as is provided by the question receiving function and/or an answer as is provided by the answer receiving function. This push-to-ask protocol layer may then be used to facilitate the automated dissemination of a question as may be provided via a push-to-ask application to, for example, a social network as corresponds to a user of that push-to-ask application and to facilitate a return of at least one corresponding answer to that push-to-ask application.

Such a push-to-ask protocol layer then provides a powerful and highly leverageable vehicle whereby various end-user platforms, via a wide variety of corresponding applications, are able to source questions of interest to the end user (or to the application itself if so desired). The propagation of these questions to potential answering candidates can be handled at essentially any or all steps of the transaction with an attendant concern and respect for a corresponding sense of trust in, for example, the answering entity and/or a trusted intervening entity that effectively vouches for the answering entity.

These and other benefits may become clearer upon making a thorough review and study of the following detailed description. Referring now to the drawings, and in particular to FIG. 1, a corresponding process 100 can provide 101, for example, a push-to-ask protocol layer. This push-to-ask protocol layer can comprise a question receiving function, an answer receiving function, a trust management function, and a propagation function. All of these functional elements will be presented in greater detail below.

It may be noted here, however, that the trust management function may be configured and arranged to maintain trust information for at least some potential recipients of a question. This in turn can facilitate an ability of the trust management function to determine how appropriate it may be in a given instance to disseminate a given question to a given candidate recipient. By another approach it may be desired to further configure and arrange the trust management function to use the trust information to facilitate splitting a question into a plurality of sub-questions and to then determine how appropriate it may be to disseminate a given sub-question to a given candidate recipient.

In some cases this trust information may comprise relatively static information. By another approach, however, the trust management function can be configured and arranged to facilitate a dynamic run-time establishment of trust as between an answering entity and a given user when the answering entity does not comprise a part of the social network as corresponds to the user of the push-to-ask application.

It may also be noted here that the aforementioned propagation function may be configured and arranged to determine propagation by, at least in part, not propagating the content upon determining that subsequent propagation is unnecessary (as when, for example, an adequate and trustworthy answer appears to be presently available) and propagating the content upon determining that subsequent propagation is necessary (as when, for example, an adequate and/or trustworthy answer does not appear to be presently available). It may also be desirable to configure and arrange the propagation function to facilitate the propagation of sub-questions as are formed by splitting a question as mentioned earlier with respect to the trust management function.

As will be explained below in more detail, it may also be desirable to configure and arrange the propagation function to be able to facilitate the propagation of a question to additional recipients subsequent to having already propagated that question to at least one previous recipient. This may be appropriate, for example, upon determining that the previous recipient (or recipients) provided an unacceptable response.

By one approach, this propagation function can be configured and arranged to determine a propagation approach with respect to content that comprises a question as has been provided by the aforementioned question receiving function and/or an answer as has been provided by the aforementioned answer receiving function as a function, at least in part, of a predetermined maximum number of entities through which such content is allowed to be propagated. Such a limit can be system-wide and/or relatively static or can be assigned on a per transaction basis depending upon the needs and/or limitations and abilities of a given application setting. In lieu of such an approach, or in addition thereto, such propagation can further be determined as a function, at least in part, of a predetermined maximum number of entities to which the content is allowed to be propagated and/or as a function, at least in part, of a predetermined time by when an answer is to be provided to a given question.

If desired, this push-to-ask protocol layer can further comprise an optional question and answer message generation function. By one approach, such a question and answer message generation function is configured and arranged to generate disseminable questions based, at least in part, upon question content as is provided by the question receiving function and/or to generate answers to received questions.

Also if desired, this push-to-ask protocol layer can further comprise an optional retransmission function. By one approach, this retransmission function can be configured and arranged to determine when to retransmit a question that has already been transmitted at least once. Such a determination can be based, for example, upon determining that the answer quality as has been provided in response to an earlier transmission of the question is inadequate.

This process 100 then provides for using 102 this push-to-ask protocol layer to facilitate the automated dissemination of a question as may be provided via a push-to-ask application to a social network as corresponds to a user of that push-to-ask application and to facilitate a return of at least one corresponding answer to that push-to-ask application. This can comprise, for example, using Session Initiation Protocol-compatible messages though other approaches as are presently known or which may be developed hereafter may be used as well if desired. As will be shown below in more detail, this usage 102 can further comprise, if desired, a use of one or more push-to-ask protocol layer templates to form the aforementioned messages to thereby provide for an appropriate presentation of the question and/or answer content and/or to arrange for appropriate propagation of the message itself.

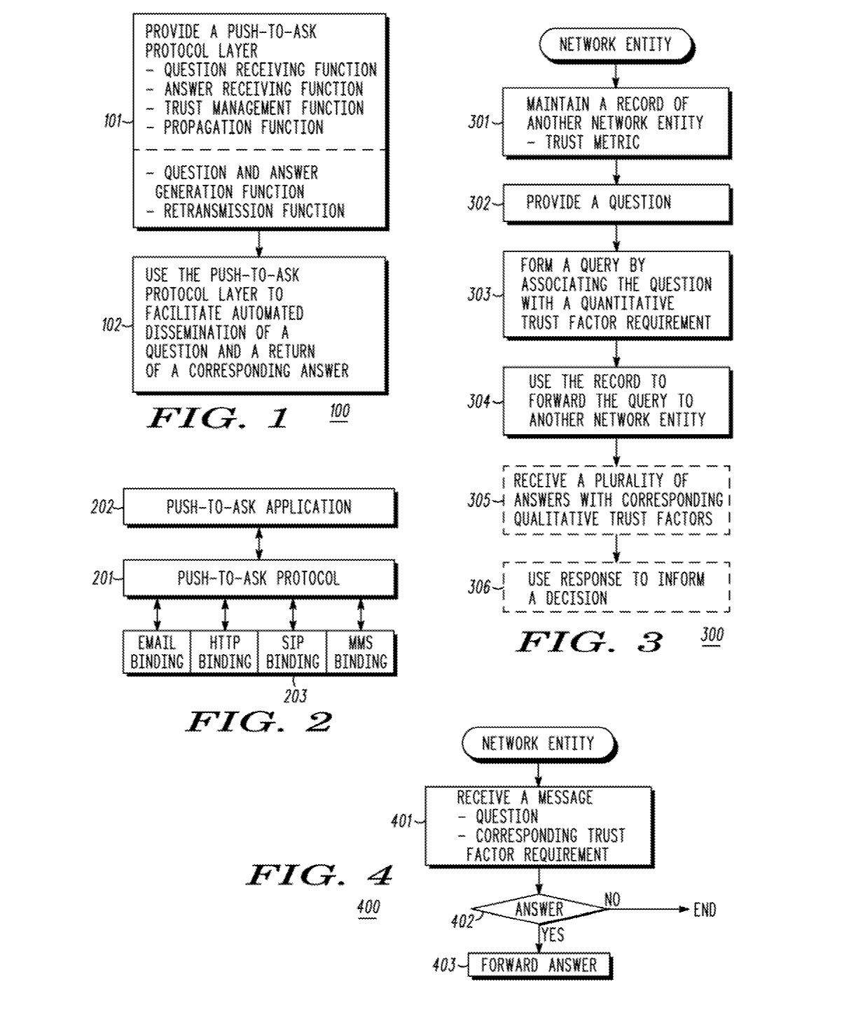

With reference to FIG. 2, a push-to-ask protocol 20 can be interposed between, for example, any of a wide variety of push-to-ask applications 202 and any of a similarly wide variety of presently known or hereafter-developed transport protocol bindings that serve to carry the aforementioned push-to-ask protocol messages. The push-to-ask applications 202 may be designed with a particular user perspective in mind (for example, dating, shopping, dining, entertainment, and so forth). Exemplary existing transport protocol bindings include, though are not limited to, email bindings, hypertext transfer protocol (HTTP) bindings, session initiation protocol (SIP) bindings, and multimedia message service (MMS) bindings, to note but a few. (For purposes of illustrative specificity only and not for purposes of limitation, many of the examples provided herein presume use of session initiation protocol bindings. Those skilled in the art will understand that other bindings can be employed as desired and may result in performance benefits depending upon the particular needs and requirements of a given application setting.)

The push-to-ask protocol 201 can be enabled via an appropriate supporting apparatus having an adequate processing platform suitable to facilitate the various functions described herein. Those skilled in the art will recognize and understand that such a platform can comprise, for example, an end device host, a network server host, or the like. If desired, it would also be possible to distribute such functionality over a plurality of discrete platforms.

Referring now to FIG. 3, a corresponding process 300 practiced by a network entity (such as an application-driven end user device) can provide for the maintenance 301 or a record of at least one other network entity such as, but not limited to, a corresponding social network comprising, for example, family members, co-workers, schoolmates, friends, and so forth (or the end user platforms as are associated with such persons or institutions). If desired, this record can relate to network entities that correlate to a specific user and can encompass, if desired, an automatic device or avatar that acts on behalf of (or even completely independently of) a given end user.

By one approach, this record comprises, at least in part, a trust metric that correlates one or more of these entities with a particular amount of trust. Examples of this indication of a particular amount of trust will be provided below. In general, however, by one approach this concept entails a quantitative expression or metric to represent the amount of trust that is associated with a given corresponding network entity.

This process 300 then encompasses providing 302 a question and forming 303 a query by associating the question with a corresponding quantitative trust factor requirement. In some cases, if desired, providing 302 a question can comprise providing a plurality of questions such that forming 303 a query then comprises forming a query by associating each of the plurality of questions with corresponding quantitative trust factor requirements. By one approach, this provision of a plurality of questions can itself comprise splitting an original question into the resultant plurality of questions. As will be discussed in more detail below, these steps of providing 302 a question and/or forming 303 a corresponding query can comprise, if desired, use of one or more previously provided templates.

This process 300 then provides for using 304 that record to forward the query to the at least one other network entity (in order to facilitate, for example, eliciting provision of a corresponding trustworthy answer to the question (or questions) being posed). By one approach this can comprise using a QUESTION generic primitive to forward the query to the at least one other entity. Depending upon the application context, this step of using 304 the record to forward the query can comprising forming a message that comprises an identity and/or address for the recipient target entity (such as, for example, an identity of a session initiation protocol entity), the question itself (in its original or in a reformatted or otherwise modified form), and the aforementioned quantitative trust factor requirement (or requirements).

As will also be discussed in considerable detail herein, this step of using 304 the record to forward the query can serve to aid the propagation processing mentioned above. By one approach, for example, this step of using 304 the record to forward the query can comprise forming a message that comprises information regarding subsequent propagation of the message by a receiving network entity to yet another network entity (or network entities). Such information might comprise, for example, a specific request to propagate the message to one or more additional network entities, a specific number of levels by which the message can be propagated to one or more additional network entities, and/or a time criteria by to govern, at least in part, the subsequent propagation of the message (and/or a corresponding answer). As will also be discussed below, this can also comprise, if desired, forming a message that comprises a request that an answering network entity participate in a source verification process (which may comprise use of encryption, digital signatures, passwords, or other source verification techniques).

In general, a primary point of presenting and promulgating a question is to receive a corresponding answer. This process 300 can therefore also optionally provide for receiving 305, for example, a plurality of answers to a question along with corresponding quantitative trust factors. This process 300 can then further accommodate the use 306 of these answers and their corresponding quantitative trust factors to inform a corresponding decision. By one approach, if desired, this can comprise selecting (automatically or otherwise) from amongst the answers to select a single most trustworthy example. By another approach, if desired, this can comprise aggregating at least some of the answers into a combined answer. Such aggregation might comprise, for example, using the quantitative trust factors as a weighting vector to influence the extent to which a particular answer contributes or influences a particular aggregate response.

The above process 300 permits a given network entity to pose questions and to receive corresponding answers. Referring now to FIG. 4, a corresponding process 400 by which a network entity can receive a question and present an answer and/or further propagate the question will be generally presented.

By this process 400, a network entity (which, again, might comprise an end user platform and/or an avatar platform for a given end user entity such as a person or institution) receives 401 from a forwarding network entity (which might comprise a source for that transmission or an intervening forwarding platform) a message comprising the aforementioned question and quantitative trust factor requirement as corresponds to that question. This process 400 then provides for determining 402 whether to provide an answer to the forwarding network entity.

Such a determination 402 can be founded upon any of a wide variety of decisional criteria. By one approach this determination 402 can comprise, at least in part, determining whether an answer can be provided that has a corresponding quantitative trust factor that at least equals the quantitative trust factor requirement posed by the received message. By another approach (which may be used in lieu of or in addition to the aforementioned approach) this determination 402 can comprise, at least in part, forwarding a message to yet another network entity (or entities), receiving an answer (or answers) to the posed question in response, and then determining whether to use one or more of these received answers (alone or in aggregation) as a response, in whole or in part, to the question.

As noted, this determination 402 can comprise use of the quantitative trust factor that accompanies and characterizes the question being posed. This, in turn, can comprise, if desired, maintaining a record such as that as have been earlier described and then comparing the trust metrics that are contained in that record with the quantitative trust factor requirement to obtain a comparison result that may be used to determine whether to forward the message to a given corresponding network entity and/or by which to consider the trustworthiness of an answer.

As noted above, a question message can contain propagation instructions, limits, and/or suggestions or preferences. Therefore, if desired, this determination step 402 can take such propagation information into account if desired. This can comprise, for example, determining whether to forward a message to another network entity as a function, at least in part, of propagation information such as, but not limited to, specific requests to propagate the message to other network entities and/or a specific number of levels or hops by which the message can be propagated to subsequent network entities.

Which this determination 402 leads to a decision to not make a response this process 400 can simply conclude. If desired, a message can be returned to indicate that the message has been received but that no adequate response is available. As another alternative, a message can be returned to indicate, when true, that an answer is available but that the corresponding trustworthiness of that answer is less than the stipulated amount.

When this determination 402 does lead to a decision to make a response, this process 400 can then provide for forwarding 403 the available answer (or answers) to the forwarding network entity. Such a message can comprise, for example, an ANSWER generic primitive or other suitable conveyance vehicle. As will be discussed below in more detail, this response can also be formed, at least in part, by use of a previously provided template (or templates).

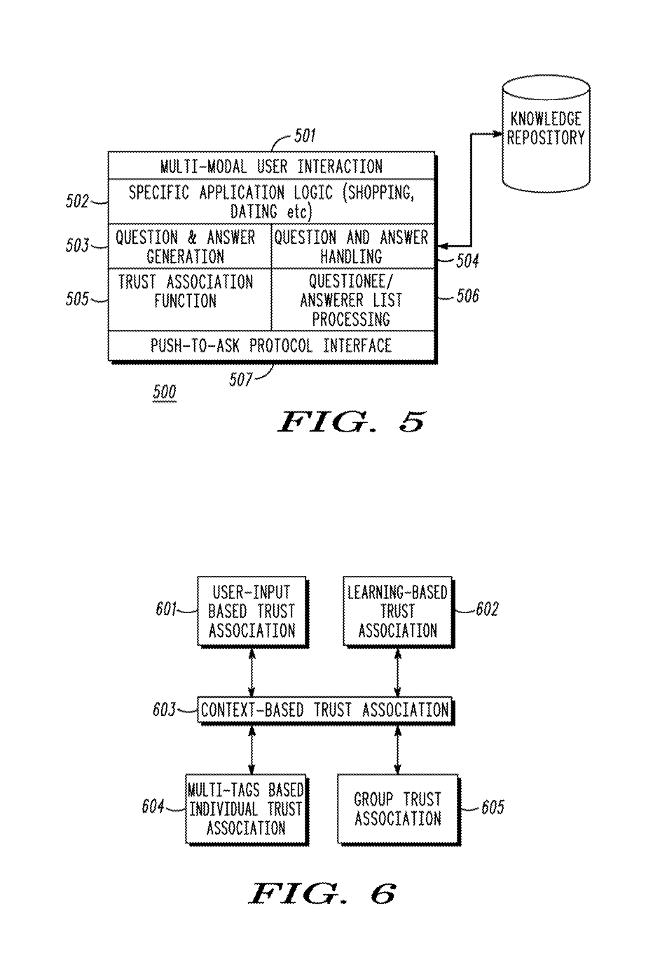

Referring now to FIG. 5, the functional architecture for a push-to-ask application layer 500 comprises a multi-modal user interaction interface 501 to provide an interface with an end user to permit the input of, for example, a specific question, to verify or select potential questionees from a corresponding list, and/or to associate trust requirements with the question (or questions) to be posed. This can comprise, for example, an ability to render information/take input from the user using any of the multi-modal input/output mechanisms suitable for the user's current and preferred device. Examples include, but are not limited to, natural language processing and an intuitive graphical user interface. By providing natural language processing a given user can express their question by speaking or typing in a relatively natural language. A graphical user interface can be used, for example, to allow input and to present questions and/or answers in a way that may be more inherently suitable for a given application.

A push-to-ask application layer 500 is further comprised, in this illustrative example, of specific application logic 502. This application logic 502 implements specific push-to-ask applications for such application specific purposes as dating, shopping, and/or general information gathering (to note but a few). The push-to-ask application layer 500 can further comprise a question and answer generation function 503 and a question and answer handling function 504 to assist with generating, for example, high-level abstract questions and/or answers to be propagated. This can also comprise, for example, filtering and/or applying weights to received answers based on any policies that may be associated with the question, the questioner, and/or the answerer.

A trust association function 505 can generally serve to manage trust requirements as pertain to questions and/or answers and further to associate trust metrics with individual entities of, for example, the user's social network. A questioner/answerer list processing function 506 serves to aid with generating or verifying a list of questionees towards whom a given question will be directed. This can comprise, for example, generating the list of intended recipients of a query message and/or verifying/filtering the generated list as may be provided by a user (using, for example, the earlier noted user-interaction function). This function can further facilitate filtering or applying weights to received answers based on, for example, any policies associated with an answerer.

A push-to-ask protocol interface 507 can act as an interface between the push-to-ask application logic 502 and the underlying previously referred to push-to-ask protocol layer (with additional details regarding the push-to-ask protocol layer appearing below as well).

Further elaboration and illustrative content regarding the trust association function 505 will now be provided. The trust association function may be split into two functionalities. One of the functionalities is for managing trust for social contacts (i.e., managing the trust factor that is associated with individual entities in the aforementioned record and as comprise the user's social network; such information may be gleaned, for example, from user input or via a corresponding learning function that monitors the user's past experience with a given entity and storing such trust factors) and the other for generating trust requirements with respect to questions and trust factors with respect to answers.

FIG. 6 provides an general overview of the trust association function as corresponds to social contacts. This function can comprise, for example, one or more means for generating trust information regarding the user's social contacts. These means can comprise, for example, user-input based trust associations 601, learning-based trust associations 602, and so forth. This function can further comprise context-based trust associations 603 based, for example, on contextual information about the social contacts. Lastly, in this illustrative embodiment, this function provides for one or more representation formats by which to characterize and/or quantify such trust associations. Illustrative examples comprise, but are not limited to, multi-tags 604 that are based on individual trust associations, group trust association 605, and so forth.

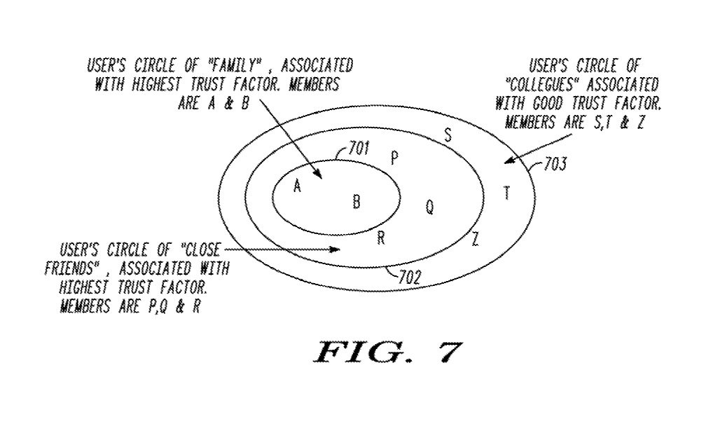

A group-based trust association 605 can comprise, for example, placing social contacts into different groups such as “friends,” “colleagues,” “family,” “clubmates,” and so forth. Each such group can have an associated general trust factor that becomes automatically associated with all of the social contacts who comprise a part of such a group. FIG. 7 provides an illustrative example in this regard. In this example, a “family” group 701 containing members A and B may be associated with a highest trust factor. A “close friends” group 702 containing members P,Q, and R may be associated with this highest trust factor as well. A third group 703, however, comprising “colleagues,” may be associated with a lower trust factor (denoted here as a “good trust factor”).

Tag-based trust association 604, on the other hand, can comprise a trust-tag that is associated with each individual social contact. By one approach each tag correlates to a certain trust factor. By one approach the resultant effective trust factor associated with a given user is cumulative of all of the trust-tags that are associated with the user. By one approach a tag may represent a negative trust-factor as well if desired. A negative value could be used, for example, to contribute towards decreasing the overall trust that is associated with a given social contact.

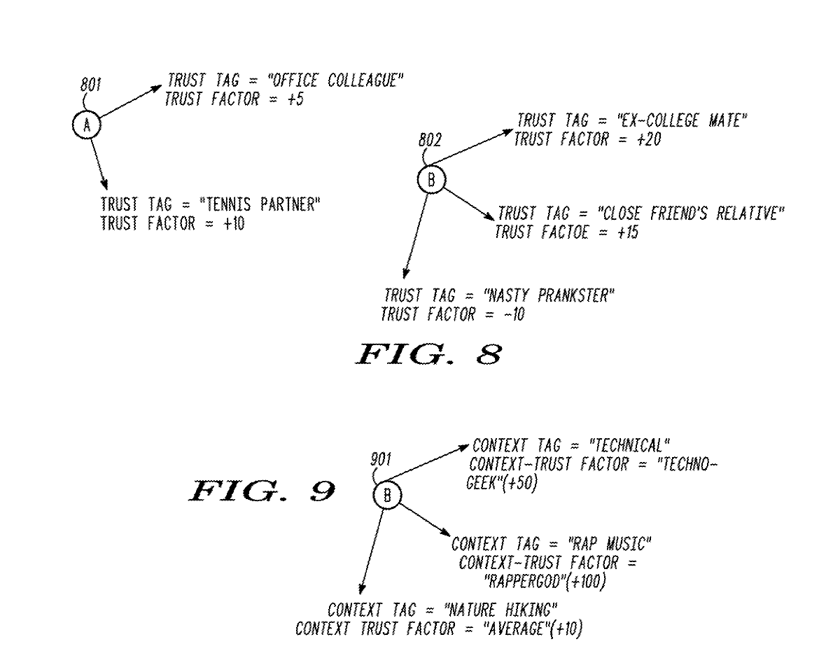

FIG. 8 provides two illustrative examples in this regard. A first social contact A has two trust tags. A first trust tag is based upon the group association “office colleague” and affords a corresponding trust factor of +5 while a second association “tennis partner” carries a corresponding trust factor of +10. A second social contact, denoted here as B, has three corresponding trust tags including a negative value trust tag to reflect B's reputation as a “nasty prankster.”

By one approach only the highest trust factor value or a given social contact might be used when considering the trustworthiness of a given social contact. By another approach the trust factors as correspond to each trust tag for a given social contact can be summed and the resultant aggregate value used as a representation of trust. By yet another approach the trust factors for each trust tag can be summed and an average (or median) then taken and used as the representational value for trust. Other approaches are of course possible.

The above-mentioned context-based trust association function 603 can reflect and otherwise take into account trust that is associated with a given social context. Such an approach is intended, at least in part, to take into account that a given social contact's trustworthiness with respect to providing a useful answer may depend upon a corresponding context as well as their own status within a particular group or with respect to their own personal standing with the user. By this approach, the trust associated with a given social contact is at least partially contextual and hence at least partially dependent upon specific application usage or type of information being sought. Different trust parameters can be associated with a same social contact to take such context sensitivity into account.

FIG. 9 provides an illustrative example in this regard. A social contact denoted as C has three contextual trust factors associated with them. A first such contextual trust factor pertains to their technical prowess (“technical”) and carries a relatively high trust factor of +50. A second such contextual trust factor pertains to their extensive knowledge of rap music and carries a relatively high trust factor of +100. A third contextual trust factor for C, however, relates to “nature hiking” and a relatively low trust factor of only +10 reflects the relative inexperience that C has with respect to this topic.

There are can be different ways by which trust associated with a social contact can be generated. By one approach users can give their inputs regarding a trust factor that they want to associate with their social contacts. User inputs would be collected and the social contacts would be tagged with the respective trust-factors. This approach can be used with any of the representation formats discussed above.

By a learning-based approach of trust management, the trust associated with a social contact changes, based on the push-to-ask application's interaction with that particular social contact. This can be more of a dynamic process, wherein each social contact's associated trust factor changes over a period of time as the system progresses. Some suggestive factors by which this dynamic trust can change might include changing trust based on the perceived goodness or value of an answer received from the social contact. Herein, the answer presented by a social contact is judged based on its value or usefulness to the user. Factors such as whether the user selects the answer or ignores it or later expresses satisfaction/dissatisfaction with the answer can all be applied when determining the value of the answer. When the user finds the answer useful, then effectively the usefulness value of the answering social contact goes up, whereas this value may go down in case of a useless answer. Thus, at each question-answer interaction, effectively the trust associated on the social contact can change and this dynamically adjusted trust then used for further question-answer interactions.

Changing trust based on the type of question asked by a social contact may also, again, be taken into account. It is possible that at times, the social contact itself would ask a question, which would give an indication about a lack of type of information that this particular social contact already has. Such a fact of lack of a particular type of information may be used later to decide whether to choose that social contact as a possible question recipient. To illustrate, if a query is received from a social contact asking for “good restaurants in the bay-area,” then it can be said with sufficient fairness that the social contact does not have sufficiently good information about “restaurants in the Bay-area.” Hence this social contact may be a less suitable candidate for questions related to either “restaurants” or “Bay-area.”

So configured, a question triggered by a user would have some trust factor requirement associated with it. Such requirements must be met before the question can be processed any further. This trust factor requirement could dictate a number of related aspects while processing the corresponding question. For example, this requirement could be used when generating a list of candidate questionees. Each social contact in the user's social network could be associated with some trust factor. In this event a given social contact must satisfy the trust factor requirements for a given question prior to being selected as a possible recipient of that question. As another example, this requirement could be used when processing a received query. Upon receiving a question, the recipient entity can look at the associated trust factor requirement and then determine whether it has sufficient corresponding trust with respect to an answer that it might return as a response.

As noted above, this trust factor requirement can be generated in various ways. By one approach user input can be employed for this purpose. Users may be given an option of setting the trust factor requirement by selecting, for example, something like a movable bar in a push-to-ask graphical user interface that would increase and decrease the required trust factor for a given question. Such an approach would allow users to choose/change the required trust factor themselves.

By another approach, context may be used as noted above. By one approach, another parameter that can be used for generating the trust factor requirement is the context as pertains to the user, the user's platform, and or the content of the question itself. For example, the relevant transactional context can be considered in this regard. If the user/mobile device is in some transaction (maybe buying something via the Internet), then the context of the transaction can be used for choosing or influencing the trust factor requirement for the question. For instance, if the user is in-between a financial transaction while issuing the query and the query is related to the transaction in some manner, then the possible financial value of the involved transaction could be used for choosing the trust factor requirement.

As another example, past history can be so employed. As one illustration, if the same question has been asked multiple times within a short span, then this may indicate that the user did not get or was not satisfied with the resultant answer(s). If the user did not get a sufficient number of answers, then the required trust factor may be reduced so as to allow more questionees to answer the Question. On the other hand, if the question was propagated to a lot of questionees and resulted in huge number of answers that were not good or simply too diluted, then the trust factor requirement may be increased so as to promote a smaller number of hopefully better answers.

By one approach consistent with these teachings, any answer for a Question should have an associated trust factor as well. This trust factor can be indicative, for example, of the trust that the answerer has in the answer. This can be used, for example, by a questioner when receiving back various answers from various social contacts. The questioner could use the trust factors that are associated with the answers to determine what level of trust the respective Answerers had with respect to the proffered answers. The questioner could then apply its own judgment to filter or prioritize the answers based on their associated trust parameters.

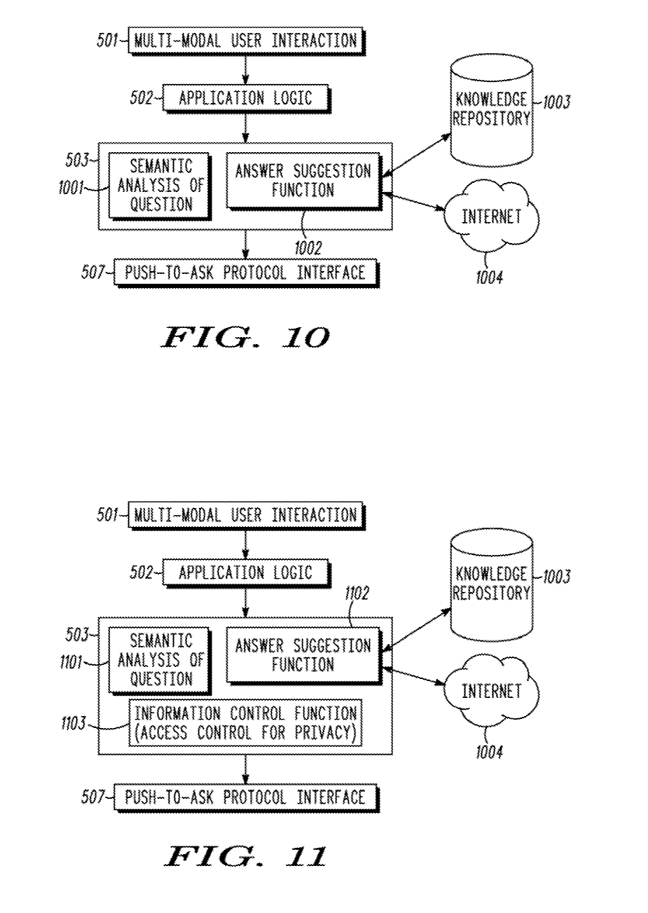

The previously mentioned question generation function can serve to aid the application logic with respect to formulating high-level questions that can be provided to the push-to-ask protocol layer for encoding into an appropriate query format and subsequent propagation to one or more suitable social contacts based on the trust factor requirement of the question. FIG. 10 depicts the general functionality of the question generation function.

In this embodiment the question generation function 503 provides for semantic analysis of a question 1001 as well as an answer suggestion function 1002. A question entered by a user may be submitted in a form comprising a set of words or phrases. The semantic analysis 1001 serves to semantically parse such input to identify the question intended by the user. The answer suggestion function 1002 can serve, for example, to facilitate the limitation of responsive answers to a particular set of candidate responses. For example, a user might be seeking to elicit identification of a best shop from amongst a list of five candidate shops. In this case this function can serve to provide the candidate answers along with the question.

Such candidate responses can be entered by the user themselves (via, for example, the multi-modal user interaction interface 501. In other cases, however, if desired, this function can facilitate an automated gathering of candidate answers (or an illustrative example answer). There are various ways by which such candidate answers can be identified. By one approach this answer suggestion function 1002 can access a local knowledge repository 1003. In lieu thereof (or in combination with a local search) this answer suggestion function 1003 can also access an external remote resource via, for example, the Internet 1004.

The question and answer generation function 503 can also provide assistance with respect to the generation of answers. FIG. 11 depicts the general functionality of the corresponding answer generation function.

A semantic analysis of answer function 1101 can serve to facilitate the proper presentation of an answer that is directly entered by a responding user. In such a case, the words and phrasing presented by the responding user can be semantically parsed to generate the specific answer to be sent by message to the questioning party.

An answer suggestion function 1002 can serve to generate candidate answers via automated means. Such a capability can be used in a variety of application settings. For example this approach can be used when the user has configured a particular question or category of questions to be auto-answered. As another example this approach can be used when the user does not recall the answer but the answer suggestion function 1103 has the ability to fetch that answer (alone or in company with other candidate options) from which the user can select the response content. As yet another example, this approach can be used to supplement a user-supplied answer that is incomplete.

There are various means and techniques by which an answer suggestion function can be facilitated. By one approach this answer suggestion function can access a local knowledge repository 1003 as mentioned above. By another approach an external source, such as the Internet 1004, can be accessed for relevant content. In addition, if desired, the answer suggestion function can retain (or have access to) relevant past history. For example, access can be provided to previous answers that were provided to this specific question and that answer (or answers) then produced as a suggested answer.

The information control function 1103 can serve to control what kind of information is being sent out as a part of an answer. This could be accomplished, for example, by applying local and/or system defined policies to filter and/or change the information being provided. This function can serve, for example, to maintain a given user's privacy by facilitating control over what parts of a user's information are shared as part of an answer.

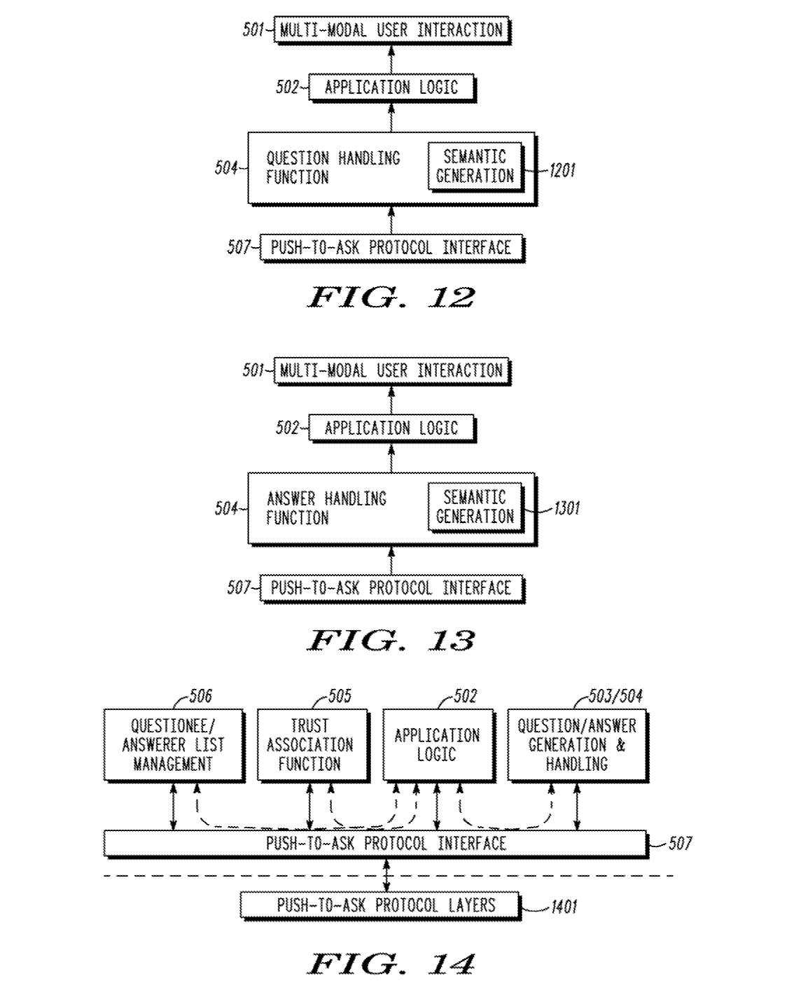

The previously mentioned question and answer handling function 504 serves, as noted earlier, to deal with incoming questions and answers. FIG. 12 provides a general view of the question handling function of the question and answer handling function 504.

The question handling function receives questions from the push-to-ask protocol layer and processes the question before passing it along to the application logic 502. In this embodiment, this comprises high-level semantic generation 1201. More particularly, a received question arrives in a format as corresponds to a particular application usage and/or as may be specified by the push-to-ask transport protocol of choice. This function 1201 serves to parse the question and generate suitable high-level semantics that can be rendered to the user and/or that can be used to inform an automated answer generation process.

FIG. 13 provides a general view of the answer handling function of the question and answer handling function 504. Here, the answering handling function again serves to provide high-level semantic generation 1301. The answers received by a given entity will typically again be presented in a format that reflects a particular application usage and/or the underlying push-to-ask transport protocol. This function 1301 can parse such answers and generate suitable high-level abstracted semantics that can then be rendered to a user and/or that can serve as suitable input to the application logic 502.

If desired, this answer handling function can further serve to effect an interaction with the answerer-list-management function by assisting with identification of which answers can be relatively trusted more than other answers based, for example, on the answerer who provides a specific answer.

Referring now to FIG. 14, the above-mentioned push-to-ask protocol interface 507 serves generally to interact with the various push-to-ask application functions and the underlying push-to-ask protocol layer 1401. As described, those skilled in the art will appreciate that the push-to-ask application functions serve generally as layers to associate trust with social contacts and application logic. Illustrative specifics of the push-to-ask protocol layer 1401 will be provided further below.

In this illustrative embodiment, the question and answer interface 507 provides for application layer functional interaction. More particularly this layer interacts with the application logic and the other application layer functions and abstracts out the push-to-ask protocol layers. Examples include, but are not limited to:
Receiving a question from the application logic 502, obtaining the associated trust factor requirement from the trust association function 505 and the questionee list prior to invoking the push-to-ask protocol layer function for propagating the question.
Receiving a question from the network and allowing appropriate interaction between the various application layer functions and the push-to-ask protocol layers.
Receiving an answer from the application logic 502 and obtaining the associated trust factor from the trust association function 505 prior to invoking the push-to-ask protocol layer for propagating the answer.
Receiving an answer from the network and interacting with the various functions such as the answerer list management function 506 and the answer handling function 504.

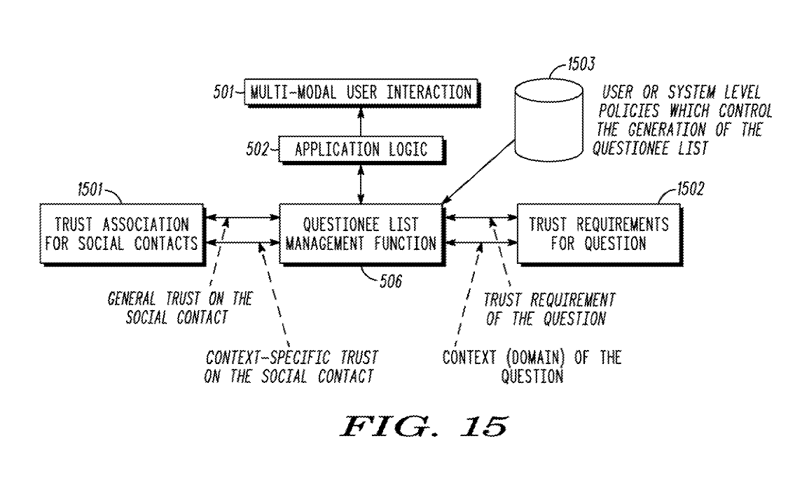

Referring now to FIG. 15, additional elaboration with respect to the questionee and answerer list management function 506 will be provided. This function 506 serves generally to use trust factors as are associated with social contacts with the user's social network to generate and/or verify a list of questionees/answerers who are (or should) be involved in the question and answer process.

A significant function of the questioneer and answerer list management function 506 comprises the generation of a list of questionees who are candidate recipients of a question to be posed. In this illustrative embodiment a corresponding list management function generates this list as a function, at least in part, of information regarding trust association for social contacts 1501, information regarding trust requirements as pertain to the question itself 1502, and user/system level policies 1503 that should be considered when generating such a list.

For example, each question can be tagged with a corresponding trust factor requirement that characterizes a required level of trust that must be satisfied before answering the question or propagating the question to another social contact. And, as noted above, each social contact can be associated with one or more trust factors.

As another example, each question will typically be asked for a particular reason; this reason can be used to characterize the question as pertaining, for example, to a specific domain of inquiry or expertise. This domain can then serve as context information to further inform this function. Such context information, in turn, can be juxtaposed with similar context-based trust indicators as were described above to assess how much a given candidate recipient may be trusted to provide a useful answer in a given context.

And as yet another example, user-level policies and/or system-level policies may be used to control what kinds of questions must or must not be propagated, expressed, or otherwise limited or controlled in view of corresponding guidelines. As a very simple example, it may be appropriate to preclude propagating a given question that necessarily itself divulges company confidential information to non-company recipients.

If desired, the questionee list management function can also interact with the application logic 502 and/or the user to verify that a generated list of candidate recipients is indeed suitable. If desired, such a user or application verification can be required before permitting propagation of a question to the list of recipients.

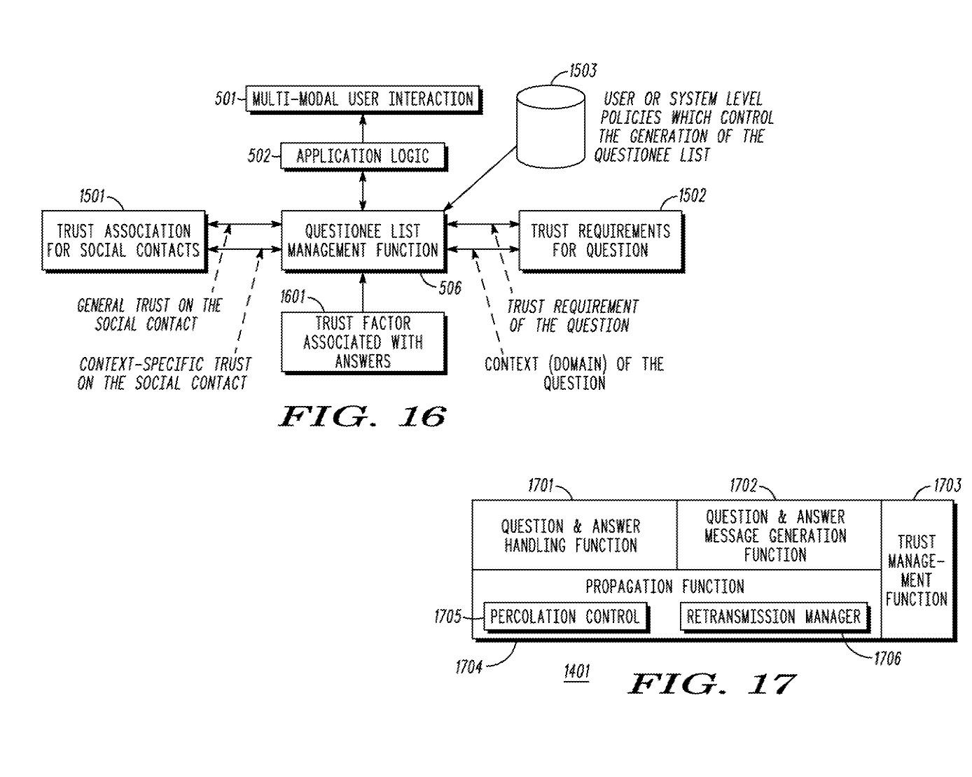

The answerer list management function aspects of the questoinee/answerer list management function 506 is generally depicted in FIG. 16. The answerer list management function serves to receive and moderate the list of answerers who have answered a given question and can make decisions regarding which answerers should be selected or given, for example, a higher or lower priority. This answerer list management function has access to the aforementioned trust association information 1501 for social contacts and the question trust requirements 1502 as was noted earlier. If desired, this function can also have access to the previously described user/system level policies 1503 as well. In this embodiment, this answerer list management function also has access to trust factors 1601 as are associated with received (or generated) answers.

So configured, the answerer list management function can consider the trust factor that is associated with a given answer and compare that with the trust factor requirements for the question being answered. In addition, the trust factor associated with the answering social contact can be considered to determine a level of trust to apply to the answer as may be particularly useful when the answer has been propagated via one or more intervening entities. If desired, this function can use context as described above to further consider a level of trust to be accorded to a given answer.

Additional description regarding an illustrative push-to-ask protocol layer will now be provided. Referring to FIG. 17, an illustrative push-to-ask protocol layer 1401 can comprise a question and answer handling function 1701 (to process questions and support answer collation), a question and answer message generation function 1702, a trust management function 1703 (to ensure and enforce the trust requirements as pertain to a given question), and a propagation function 1704 (where the latter may be comprised, for example, of a percolation control 1705 and a retransmission manager 1706).

The propagation function 1704 can provide functions for both query and answer propagation. By one approach a push-to-ask protocol layer will receive a query or an answer message only when it is specifically in the path of propagation. This occurs when an upstream entity has found it suitable that the message be passed to the present recipient. Somewhat unique to these teachings, the recipient entity will typically both process the message to ascertain whether it can make its own substantive contribution as well as consider subsequent trust-based propagation of that message. Note that propagation can be considered both in response to receiving an external message (either a question or an answer) and also in response to a query being received via the question generation function 1702.

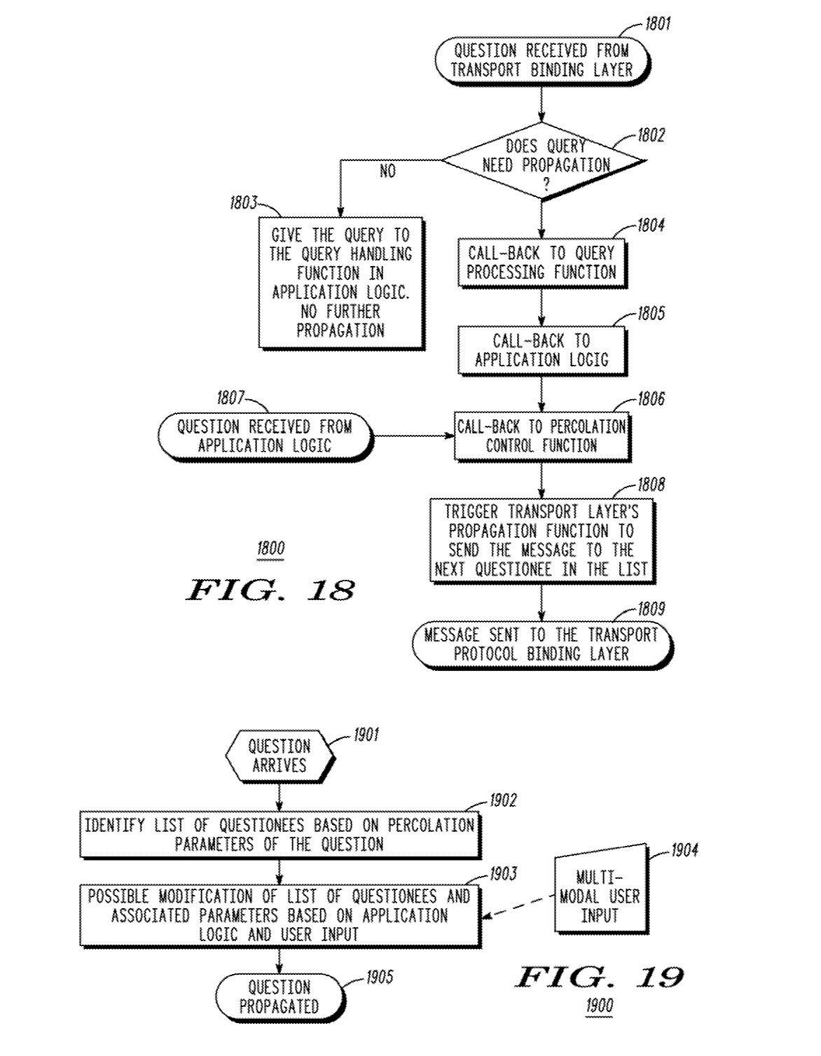

Referring now to FIG. 18, a process 1800 to facilitate the processing of a transport binding layer-received question provides for receiving 1801 a question via the transport binding layer and then determining 1802 where the received query needs propagation. To illustrate, when a corresponding questionee identifier correlates to the present recipient and when the message contains a specific indication that no further propagation is to occur, this determination 1802 can be negative. In such a case, this process provides for giving 1803 the query to the query handling function and no further question propagation occurs.

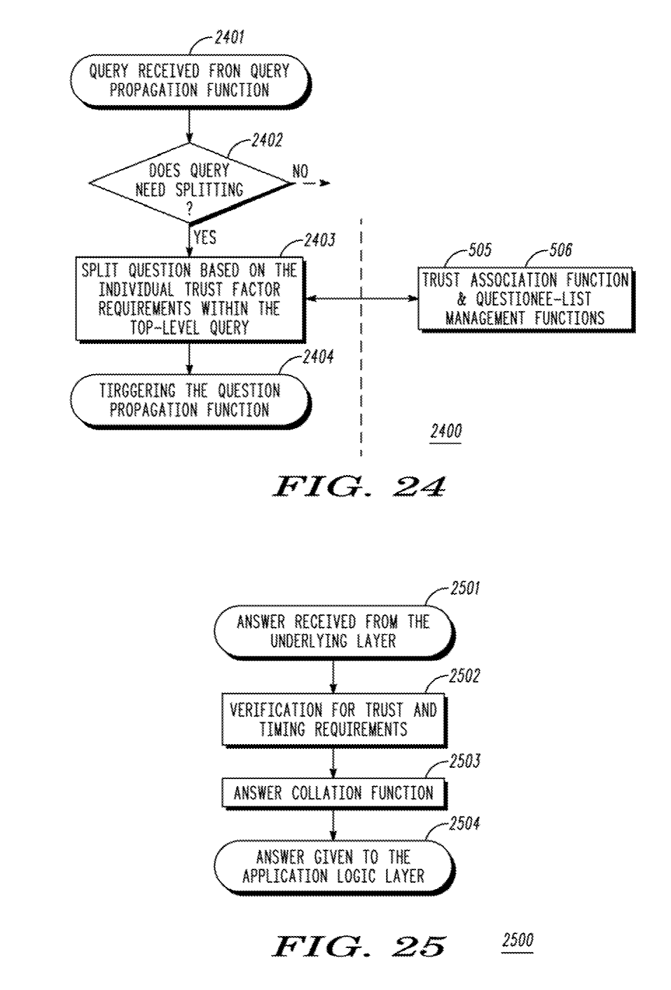

Upon determining 1802 that further propagation should occur, however, this process 1800 can then provide for calling back 1804 to the query processing function (further elaboration in this regard is provided below with respect to FIG. 24). This can serve, for example, to automatically split a given query that contains multiple questions into multiple queries. In such a case, of course, it may be desirable to imbue each question of the sub-set with the trust and contextual requirements as were provided with the original question.

This process 1800 can also provide for calling back 1805 to the application logic. This can include, for example, calling back to the questionee list management function, the query handling function, and/or the question generation function as appropriate and/or as desired. This can result, for example, in changing the query which may, in turn, lead to changes with respect to a candidate list of recipients to whom the query is to be propagated.

This process 1800 can also provide for calling back 1806 to the percolation control function. As will be described in more detail below, the percolation control function serves to control the propagation aspects of the query message. (As noted earlier, a question can also be received from the application logic itself rather than via the transport binding layer. In such a case, if desired, a question received from the application logic 1807 can enter this process 1800 at the point of engaging the call back 1806 to the percolation control function.)

This process 1800 then triggers 1808 the transport layer's propagation function to cause the message to be sent to the next questionee in the list. This can comprise, for example, removing the identifier/address for the next questionee from the forward-questionee-list (the latter then comprising a part of the query message itself). The message is then sent 1809 to the transport protocol binding layer.

A view of the question propagation function that spans both the push-to-ask protocol layer and the application layer appears in FIG. 19. Generally stated, when a question arrives 1901, a list of questionees is identified 1902 based, at least in part, on percolation parameters as may be represented by or contained within the question. Consideration 1903 is then provided with respect to modifying that list and possibly one or more associated parameters base on application logic and/or user input (the latter being provided, for example, via multi-modal user input 1904). The question is then further propagated 1905 as appropriate.

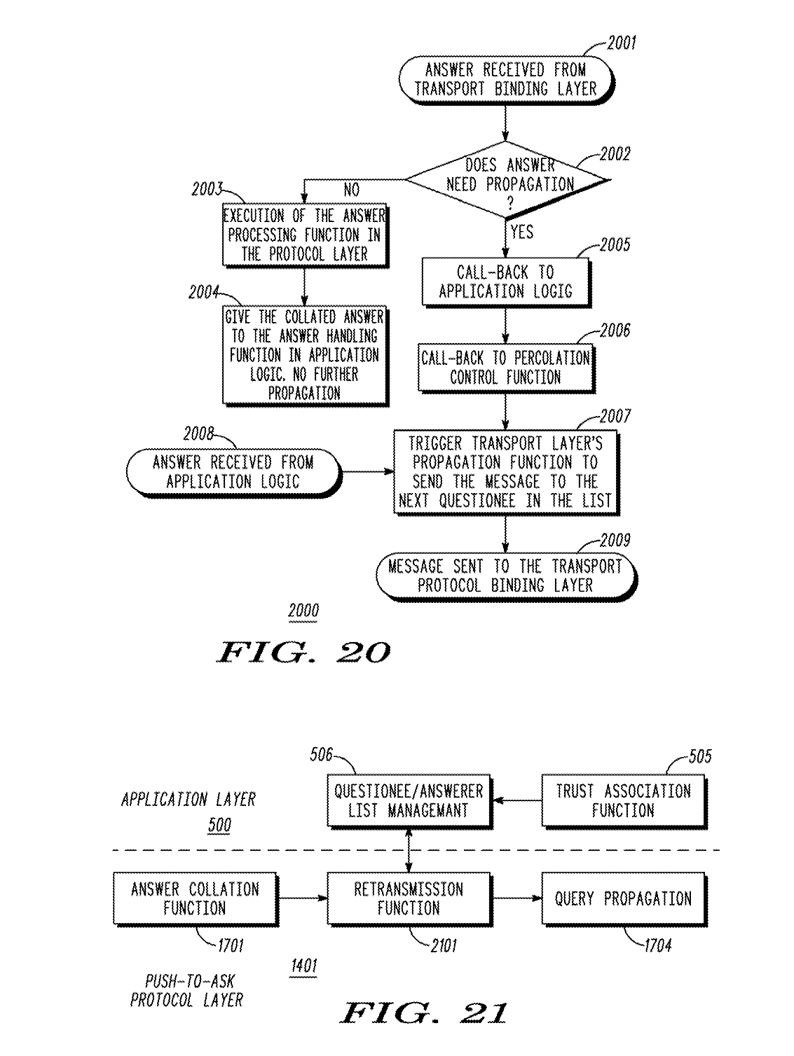

An answer to a question generally requires propagation when either an answer is received from the network via the underlying transport protocol binding layer or is received from the application logic's answer generation function. A corresponding process 2000 appears in FIG. 20.

Upon receiving 2001 an answer from the transport binding layer, this process 2000 then provides for determining 2002 whether to further propagate that answer. For example, when the forward-questionee-list for the answer message indicates that no further propagation should occur, this determination can be negative. In such a case, this process 2000 then executes 2003 the answer processing function in the protocol layer and gives 2004 a corresponding answer (such as a collated answer) to the answer handling function in the application logic (all without further propagation of the answer).

Upon determining 2002 that further propagation is appropriate, however, this process 2000 provides for calling back 2005 to the application logic (for example, to the answerer list management function, the answer handling function, and/or the answer generation function) where the answer may possibly be changed, in substance and/or form and where the propagation list may also be changed. This process 2000 can also provide for calling back 2006 to the percolation control function to facilitate controlling the propagation aspects of the answer message.

This process 2000 then triggers 2007 the transport layer's propagation function to send the message to the next questionee in the list. In such a case, if desired, an identifier/address for a next questionee (i.e., the intended target to whom this answer is next being sent) is removed from the forward-questionee-list when the latter is added to the answer message. (As noted earlier, an answer can also be received from the application logic itself rather than via the transport binding layer. In such a case, if desired, an answer received from the application logic 2008 can enter this process 2000 at the point of triggering 2007 the transport layer's propagation function.) This, in turn, will result in the message being sent 2009 to the transport protocol binding layer.

The aforementioned percolation control function 1705 serves to control the propagation aspects of a push-to-ask protocol message. This can comprise, for example, controlling a depth of propagation or a width of propagation, and/or using time-based propagation control. Depth of percolation refers to a maximum number of entities through which a question (or sub-questions) can be propagated. When such a limit has been established a given query will not be further propagated when that limit has been met in a given application setting. Width of percolation refers to how many nodes to which a given question can be essentially simultaneously propagated (by, for example, any given node). A time-based propagation control relates to indicating, for example, a maximum time duration during which answers may be accepted and further propagated. Using this approach, an answer that is received too late (as measured by this maximum time duration) will not be further propagated.

Such percolation control factors can themselves be generated, if desired, as a function of trust requirements, a perceived social contact circle for a next node, time limits as pertain to a needed answer, and/or perceived contextual expertise of a next node (or nodes), to note but a few examples. As to trust requirements, when a trust factor requirement is relatively high a lower value for depth and width of propagation may be generated or otherwise selected. Conversely, when a relatively lower trust factor requirement applies, higher values for depth and width of propagation may be used to thereby encourage potentially wider propagation of the question.

As to perceptions regarding the social contact circle of a next node, when a next node is perceived as having a relatively good and large social contact circle, the width and depth of propagation parameters may be set to accordingly to minimize undue propagation through that social contact circle and/or to solicit a relatively broad based response as may best accord with the needs of a given questioner.

As to answer-based time limits, when there are sufficiently stringent timing constraints in place with respect to receiving an answer, a higher value for the depth and width propagation parameters can be used to allow the question to reach a relatively higher number of recipients (thereby increasing a likelihood of receiving a timely answer). Similarly, when the answer timing requirements are more lenient, the query may be more carefully propagated. This approach may be particularly useful when applied in conjunction with re-transmission as described below.

As to perceptions regarding contextual expertise for a next node, when a next node is perceived to have access to good contextual knowledge regarding the domain of the question, the percolation parameters may be set relatively narrow and shallow in anticipation of the next node likely being able to provide a useful answer. Conversely, such parameters can be set more leniently when a next node appears to be without contextual expertise.

By one approach such width and depth parameters can be co-related, at least in part, and can be derived using existing graph theory. For example, a maximum depth can be set to 6 based on Milgram's theory of the six degrees of separation. As another example, in a closed network that resembles a regular graph the maximum depth will not exceed n/2k where n equals the number of network entities and k is the number of nearest neighbors for each entity. As yet another example, when a closed network is better characterized by a random graph the maximum depth may be set to not exceed log(n)/log(k).

By one approach, if desired, the push-to-ask protocol layer can provide for retransmissions of questions (apart, that is, from retransmissions that may be occur in order to ensure that a particular transmission is in fact received). Such re-transmissions are done for reasons of trust and not channel reliability. For example, a re-transmission may be appropriate when no good answers are received in response to having propagated a given question to a first list of candidate answerers.

FIG. 21 provides a general depiction of a push-to-ask protocol layer 1401 that comprises a retransmission function 2101. This retransmission function 2101 can serve, for example, to analyze received answers (as provided, for example, by the answer collation function of the question and answer handling function 1701) and identify whether such answers satisfy the required trust requirements (as provided, for example, by the trust association function 505). When such conditions are not met, this retransmission function 2101 can facilitate retransmitting the question (via, for example, the query propagation function 1704) towards a different set of questionees and/or to an already-used set of questionees with different trust requirements.

To illustrate, a question may have been first propagated to a particular subset of a list of available questionees as provided by the application layer 500. In this illustrative example, no trustworthy useful answers were received in response to this first round of propagation. This retransmission function 2101 could react in such an instance to provide for using a different subset of the available questionees, modifying the propagation parameters regarding depth, width, or time constraints, and/or by modifying the attendant trust factor requirements. This, of course, could be repeated as necessary should a first retransmission prove unsuccessful with respect to eliciting a useful answer.

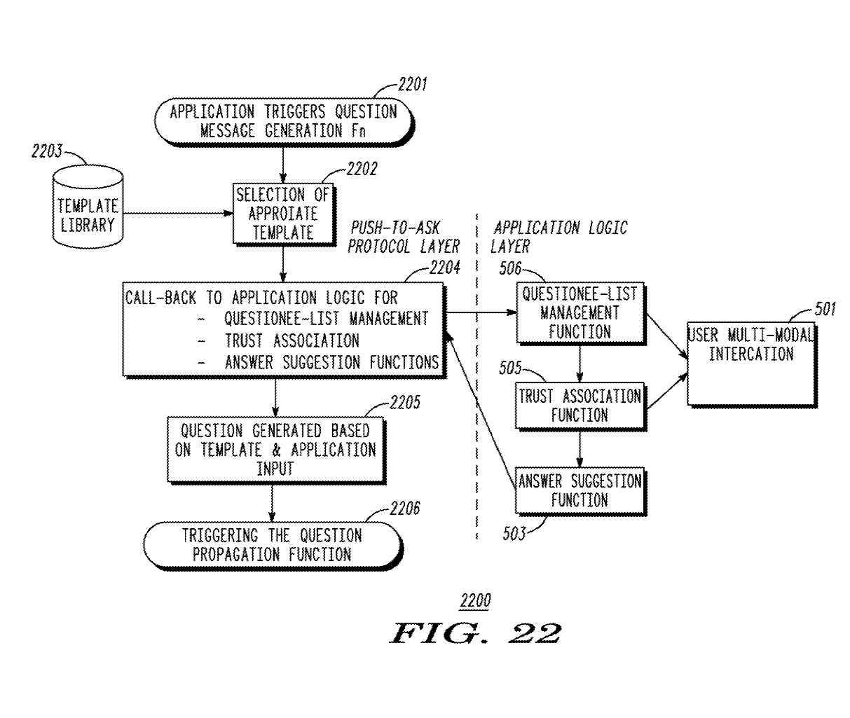

The previously mentioned question and answer generation function 503 of the push-to-ask application 500 can comprise a question message generation function. This function could be invoked 2201 by the application to formulate a specific push-to-ask query message for a given question as shown in FIG. 22. By one approach this can then lead to selection 2202 of an appropriate template. This template might be provided in a given instance by the application logic itself or might be otherwise selected by the question message generation function itself (by accessing, for example, an available template library 2203). Template usage permits the implementation of a generic question message generation function that can formulate query messages for essentially any domain where the information can be characterized by a question template (addition detail regarding such templates will be provided below).

This process 2200 then provides for a call back 2204 to the application logic (including, for example, such application logic layer elements as the questionee/list management function 506, the trust association function 505, and/or the answer suggestion function 503) and/or to push-to-ask protocol layer functions such as the percolation control function to determine parameters to be used when forming the query message. A corresponding question can then be generated 2205 using these inputs and template content and the question propagation function then triggered 2206 to cause the forwarding of the generated question to the target recipient (or recipients). Those skilled in the art will further recognize and understand that a given question can be generated as a function, at least in part, of a minimum requirement with respect to trust factor requirements (for the answerer and/or the propagators), permission, refusal, or a requirement that a question be answered by automata and/or via user intervention, and/or timing requirements for a corresponding answer.

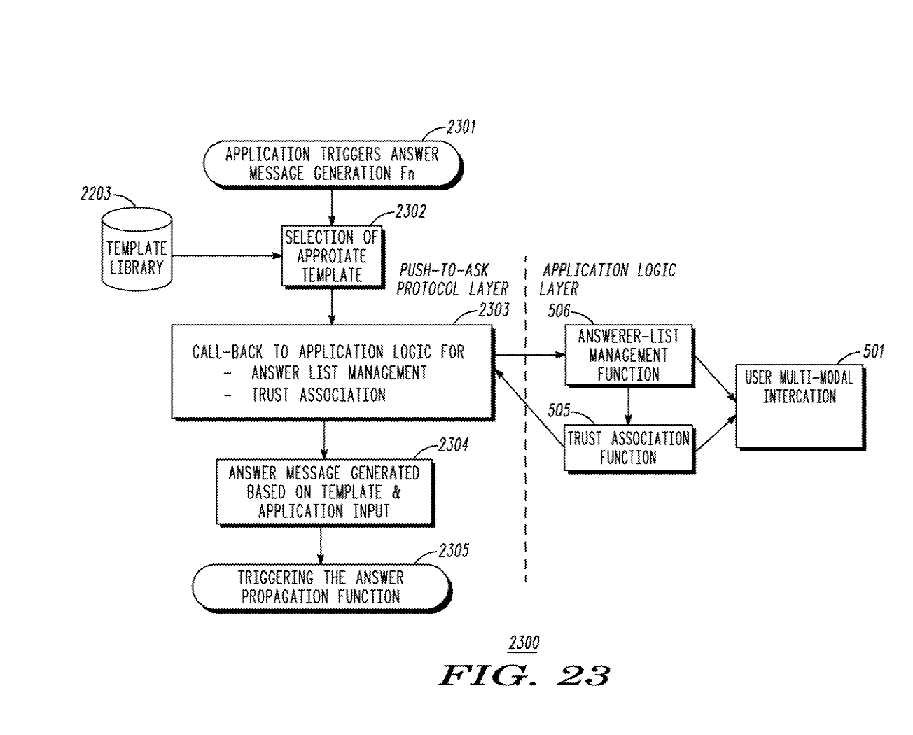

Referring now to FIG. 23, a similar process 2300 can be provided to facilitate the generation of an answer message. By this process 2300, upon triggering 2301 an answer message generation function can again select 2302 an appropriate template in order to assure provision of an answer message that is compatible for use with the push-to-ask application that sourced the original question.

This process 2300 then provides for a call back 2303 to the application layer (such as, but not limited to, the answerer list management function 506 and/or the trust association function 505) and/or to such push-to-ask protocol layer functions as the percolation control function to determine the parameters (such as an answerer list, a level of trust to be associated with each answerer, and so forth) to be used when generating the answer message. An answer message is then generated 2304 using, for example, appropriate encoding, the selected template, and the determined parameters and handed over by triggering 2305 the answer propagation function.

Referring now to FIG. 24, a query splitting process 2400 that can comprise a sub-part of the query processing function referred to earlier will be described. Upon receiving 2401 a question from a questioner or a query propagation function, this process 2400 then determines 2402 whether the query could or should be split. When splitting does not appear to be appropriate or possible, this process 2400 can simply provide for question handling as is otherwise described herein. Upon determining 2402 that splitting is appropriate, however, this process 2400 can then split 203 the question. This splitting can occur as a function, for example, of individual trust factor requirements that may be present within the top-level expression of the query (which may, in turn, be available via the trust association function 505, the questionee-list management function 506, or other source of choice).

Such splitting may be done, for example, to effectively filter information for the application logic layer. By this approach, only those sub-questions for which a particular node is able to satisfy the trust factor requirements will be propagated. As another example, breaking a given question into multiple questions can be used to appropriately parse particular contexts amongst a variety of different possible recipients who satisfy the corresponding trust requirements. Once split, this process 2400 can then trigger 2404 the question propagation function.

Referring now to FIG. 25, an answer processing function 2500 can serve to handle multiple answer messages. This can comprise, for example, receiving 2501 multiple answers from the underlying layer and then verifying 2502 the trust and timing requirements as may be applicable to such answers. The processed answers may then be collated 2503 and the resultant answer given 2504 to the application logic layer.

Such an approach can be useful to ensure verification of the applicable trust requirements. For example, this process 2500 provides for ensuring that a given answer has a corresponding trust factor that equals or exceeds a required trust factor. And, when multiple answers are received for a single question, this process 2500 can provide for a way to provide a merged response. By one approach, for example, answers with a same trust factor can be clubbed together to provide a single answer to the user. When answers having different trust factors are provided, one may elect instead to not collate those answers or to combine or present them in some fashion that takes their respective trust valuations into account.

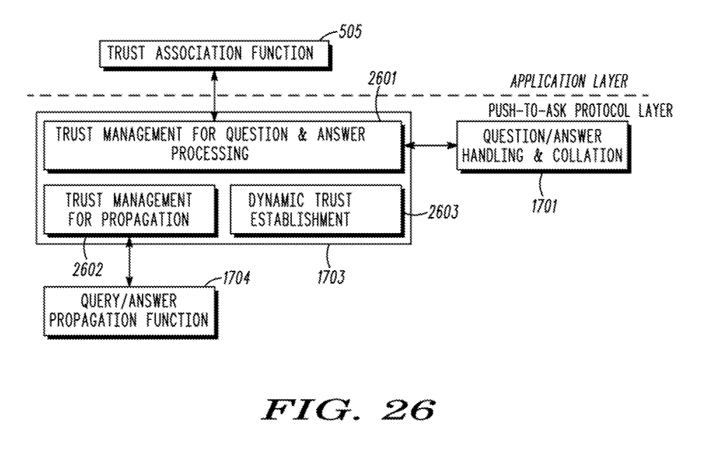

Referring now to FIG. 26, the push-to-ask protocol layer's trust management function 1703 serves, at least in part, to ensure that push-to-ask protocol messages that traverse through the various questionees and answerers adhere to the trust requirements as pertain to the question as well as trust factors that may be associated with the social contacts to which the questions/answers are being propagated to or collated from. This trust management function 1703 can comprise, for example, a trust management for question and answer processing function 2601, a trust management for propagation function 2602, and a dynamic trust establishment function 2603.

This trust management for propagation function 2602 can serve to facilitate the trust-based propagation of questions. This can comprise, for example, the forwarding of questions when a questionee needs to propagate a question towards another set of questionees. This might occur, for example, when the query contains a forward-list of questionees to which the questioner wants this questionee to propagate towards. This might be appropriate and useful, for example, when the questioner knows a particularly appropriate recipient who may have a useful answer but where the questioner cannot directly present the question because of the lack of a pre-existing trust relationship between them. In this case the questioner can request the assistance of the questionee to act as an intermediary by forwarding the question to that identified party.

The trust management function can serve, for example, by accessing a list of questionees and analyzing whether the listed entities satisfy the specified trust requirements as pertain to a question before permitting the forwarding of the question in such a case. In this case, for example, the trust management function could refer to the application layer trust management function to identify the trust associated with the list of requested questionees to inform this decision.

This trust management function can also facilitate the question splitting process discussed above. In particular, as already noted, trust requirements must continue to be observed when splitting a question and forwarding the resultant sub-questions and the trust management function can act to ensure that such requirements are met. This can comprise, for example, ensuring that trust factors are correlate to sub-questions are met by the trust factors of the social contacts to whom the sub-questions are to be propagated.

The trust management for propagation function 2602 can also provide support with respect to the propagation of answers. In general, answers are only propagated to a single questioner and are not ordinarily to be propagated to multiple entities. The answer may itself comprise a list of questioners through whom the answer should be propagated. Reverse propagation of the answer permits an answerer to provide a response to a questioner with whom the answerer does not otherwise have a trust relationship.

When a question is being propagated within the social network of a given user, the question can be answered by a first level social contact of that user (for example, a social contact to whom the user had initially propagated the question). In such an instance there is a know and pre-existing known trust factor which the user (or questioner as the case may be) has for the questionee that can be used to effect a trust analysis as described herein. It is also possible, however, for a second (or more) level social contact of the user to become an answerer (as when a question is propagated via intermediary questionees who act as questioners on behalf of the user as described herein). In such a case there may be no prior basis for trust as between the ultimate answerer and the original questioner.

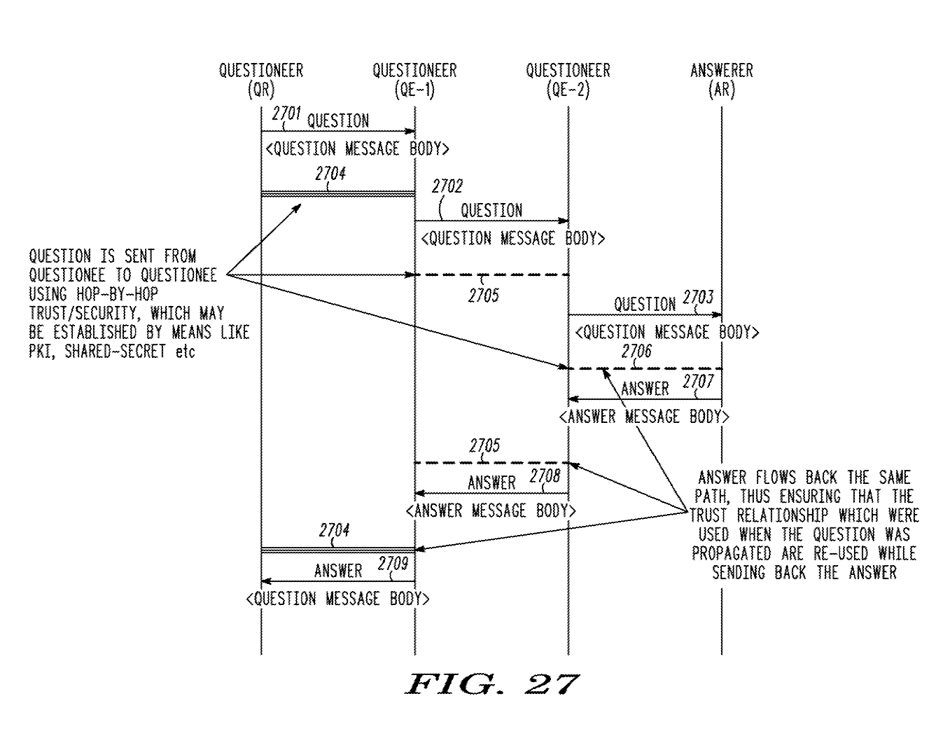

By one approach, and referring now to FIG. 27, the answer can be traversed back through the social chain to the questioning user. In this illustrative example, an original question message 2701 as is transmitted to a first questionee (QE-1) is further propagated via another questionee (QE-2) to an answerer (AR) using corresponding propagated question messages 2702 and 2703. In this example, each such propagation instance uses a corresponding instance of hop-by-hop trust and/or security 2704, 2705, and 2706. Each such instance can comprise a different kind and/or basis of trust/security as has already been established between the transmitting entity and the receiving entity. Examples include, but are not limited to, public key infrastructure (PKI), shared secret-based techniques, and so forth.

In turn, the answerer (AR) can transmit an answer 2707 back to its forwarding questionee (QE-2) (again using the same trust/security relationship mechanism 2706 as served to permit propagation of the question from this questionee (QE-2) to the answerer (AR)). In turn, the second questionee (QE-2) can propagate an answer message 2708 using its trust/security relationship mechanism 2705 with the first questionee (QE-1) and the latter can then propagate an answer message 2709 back to the original questioner (QR) using, again, the same trust/security relationship mechanism 2704 as had previously served to facilitate the original transmission of the question between these nodes.

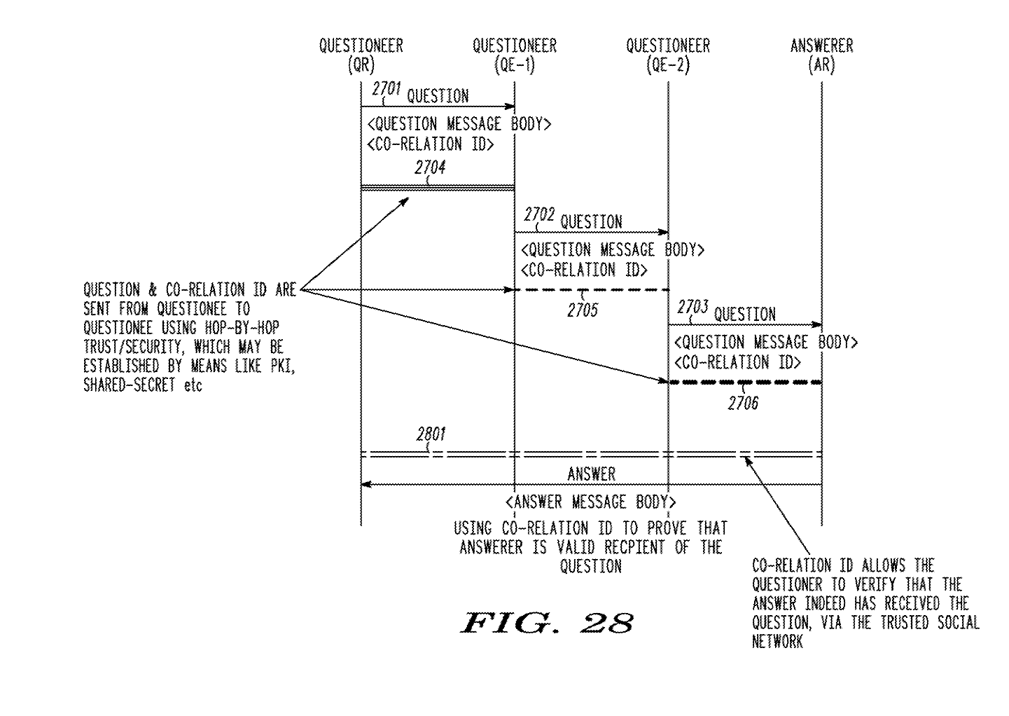

In the alternative, and referring now to FIG. 28, the question propagation process can proceed as described above with respect to FIG. 27. In this example, however, the answerer (AR) and the questioner (QR) dynamically establish a trusted session 2801 between themselves to permit a direct provision of the answer from the answerer (AR) to the questioner (QR) without requiring the services of the intervening questionees. The previously mentioned dynamic trust establishment function 2603 can serve in this regard.

For example, the dynamic trust establishment function can generate a random and unique co-relation identifier. This co-relation identifier could be sent through the network along with the propagating query. Possession of the co-relation identifier by the answerer (AR) could be used to establish and prove that the question was in fact received through a trusted social network. Such a co-relation identifier could be returned, for example, in the answer message to thereby permit the answerer (AR) to respond directly to the questioner (QR).

Attention will now be paid with respect to protocol semantics for the query protocol. To begin, an illustrative template for a push-to-ask protocol query message can comprise the following:

```
<Query>
  <Questioner-id> ... </Questioner-id> // Continues to identify the Original Questioner, even after multiple
                  // propagations of the Question
  <Query-id>...</Query-id> // Query Identifier. Used to co-relate the replies
  <Forward-Questionee-list> // List of further Questionees (QEp-r), whom the recipient Questionee
        // must propagate the Query to. NULL means “Do NOT propagate Questions”
    <Questionee-id> // Identifies the Questionee (QEp), whom this Questioner wants the Query to be forwarded to
      <Questionee-list>...</Questionee-list> // In-case, Questioner wants QEp to forward Query to another list
    </Questionee-id>
  </Forward-Questionee-list>
  <Backward-Questionee-list> ... </Backward-Questionee-List> // List of Questionees, who have forwarded Query
  <Max-propagation-per-Questionee/> // Controls the width of propagation at each Questionee.
            // “Do not propagate Query to more than X Questionees”
  <Max-Questionees-acting-as-Questioners> // Control the depth of propagation of the Questions
  <Max-time-for-answer/> // Maximum time within which answers would be accepted
  <Trust-factor-requirement>...</Trust-factor-requirement> // Questioner's requirement on the trust-worthiness of the Answerer
and the trust on the Answer. In other words “Don't answer me, unless you trust the Answer to this much level and you are a trust-
worthy Questionee”
  <Context-co-efficient-requirement>...</Context-co-efficient-requirement> // Questioner's requirement on the ability
            // of the Questionee to answer this particular question
  <Co-relation Id>...</Co-relation Id> // Possession of this Co-relation Id proves to the Questioner that the Answerer is a valid
recipient of the Question, which has been propagated through the Social Network.
  <Question-list> //List of Questions
  <Question> // De scribes a single Question
    <Question-id>...</Question-id> // Unique Question Identifier. Used for co-relating Answer
    <Application-usage>...</Application-usage> // Specific Application Usage for e.g. Payment, Reputation etc
    <Question-rendering>...</Question-rendering> // How the Question should be rendered to the User?
    <Trust-factor-requirement>...</Trust-factor-requirement> // this is the individual Trust Factor Requirement on this specific
Question
    <Application-specific-Question-format/> // Actual Question
  </Question>
  </Question-list>
</Query>
```

Various parameters appearing in this query protocol message are described as follows:

Questioner-ID: This parameter identifies a questioner in the network. This may comprise, for example, a uniform resource identifier (URI) and is preferably though not necessarily globally unique (or at least unique with respect to the propagation possibilities as pertain to a given query). This parameter is intended to identify the original questioner. During propagation, however, it is possible or even likely that a given questionee will change this value to reflect itself rather than an original questioner. This may be done, for example, for reasons of trust. By one approach an answerer will not answer a question based on only the presence of a certain questioner-ID in the query as it is possible for a questionee to present another user's ID to try and elicit unauthorized results. Instead, answers to a previous intermediary hop may, by one approach, be based on only the trust relationship that an answerer has in the questioner who sent the question in the first instance (as might be established, for example, by using existing session initiation protocol-based identity and security mechanisms.

Query-ID: This parameter identifies a particular question. By one approach this parameter must be echoes back by the answerer in a proffered answer. This parameter can be used by a questioner (or intervening questionee) to co-relate and collate different response to a given question.

Forward-questionee-list: This parameter contains a list of further questionees which the questioner (that is, the originator of the question) wants the questionee to further send the query to. Each element in the list can identify a specific questionee. When multiple entries are present in the list, it can serve to indicate that the questioner wants the query to be sent to multiple recipients simultaneously. When NULL, then this can indicate that the questioner is directing the questionee to not propagate the question to further entities. By one approach this parameter can include a questionee-ID sub-parameter. Each questionee-ID can indicate a specific questionee to whom the questioner want the query to be propagated. This sub-parameter, in turn, can contain a forward-questionee-list sub-sub-parameter. This forward-questionee-list can be used to indicate that the original questioner wishes for the questionee to forward the query to another questionee who, in turn, should forward the query to the entities identified in the forward-questionee-list. Accordingly, an essentially complete path can be identified by a questioner if so desired. This forward-questionee-list could appear as follows:

```
<Forward-Questionee-list>
    <Questionee-id>
    C@domainC.com
        < Forward-Questionee-list >
            <Questionee-id>
            D@domainD.com
                < Forward-Questionee-list >
                    <Questionee-id>
                    E@domainE.com
                        < Forward-Questionee-list >
                        NULL
                        </ Forward-Questionee-list >
                    </Questionee-id>
                </ Forward-Questionee-list >
            </Questionee-id>
        </ Forward-Questionee-list >
    </Questionee-id>
</Forward-Questionee-list>
```

Backward-questionee-list: This parameter lists the questionees who have already forwarded a question before that question reached a current questionee. Each element of the list can comprise a questionee-ID.

Max-propagation-per-questionee: This parameter can serve to specify the width of propagation as may occur for the query at each node during message propagation.

Max-questionees-acting-as-questioners: This parameter can specify the depth of propagation that is allowed through the network. As each questionee further propagates a given query, for example, this parameter may be reduced to thereby indicate a remaining number of permitted propagation instances.

Max-time-for-answer: This percolation control parameter can specify the time bounds within which an answer should be provided. If desired, this parameter can comprise a clock value that will be understood within a given network without ambiguity.

Trust-factor-requirement: This percolation parameter specifies the trust factor requirements for a given question.

Context-co-efficient-requirement: This percolation parameter specifies the context co-efficient requirement for a given question.

Co-relation ID: This parameter can specify a unique co-relation identifier that can be propagated along with a question to permit a given answerer to prove to the original questioner that the answerer is a valid recipient of a given question.

Question-list: This parameter can contain a set of “questions” (where “questions” comprise a parameter as is defined below).

Question: This field contains a single question in its entirety and is, in this example, composed of a question-ID field, an application-usage field, a question-rendering field, a trust factor requirement field, and an application-specific-question-format field. The question ID field comprises a unique identifier for the question within this query (with this field having particular use when seeking to collate related answers). The application-usage field identifies the type of application that the question pertains to and hence serves to establish a context for the question. The question-rendering field contains information about how to render a particular question to the user. The trust factor requirement field comprises the trust factor requirement as pertains to this question. And the application-specific-question-format field contains the application specific question template that is selected from, for example, a template library. So configured, the question can be embedded in a template to facilitate uniform and easy user/automated interaction therewith.

An illustrative template for a push-to-ask protocol answer message can comprise the following:

```
<Reply>
  <Answerer-id> ... </Answerer-id> // Continues to identify the Answerer.
    // Even after the Answer has passed through multiple intermediary Questionees
  <Query-id>...</Query-id> // From the Query, to which this Reply is being sent
  <Question-propagation-list> // The Questionee chain, before the Original Answerer received the Query
    <Questionee-id> // Identifies the Questionee, who forwarded Query to this Answerer
      <Questionee-list>...</Questionee-list> // Further, list identifying how the previous Questionee had received the Query
    </Questionee-id>
  </ Question-propagation-list >
  <Forward-Questionee-list>...</Forward-Questionee-list> // Identifies the further list of
        // Questionees, whom this Answerer wants the Answer to pass through
  <Backward-Questionee-list>...</Backward-Questionee-list> // Identifies the list of
        // Questionees, through which this Answer has passed before reaching this node
  <Associated-trust-factor>...</Associated-trust-factor> // Trust placed in Answer by Answerer
  <Co-relation Id>...</Co-relation Id> // Possession of this Co-relation Id proves to the Questioner that the Answerer is a valid
recipient of the Question, which has been propagated through the Social Network.
  <Answer-list> // Contains the list of Answers
  <Answer> // Describes a single Answer
    <Question-id>...</Question-id> // Question Id - used for co-relation with Question
    <Application-usage>...</Application-usage> // Specific Application usage for this Answer
    <Associated-trust-factor>...</Associated-trust-factor> // Trust placed in this particular Answer by Answerer
    <Application-specific-Answer-format/> // Actual Answer information
  </Answer>
  </Answer-list>
</Reply>
```

Various parameters appearing in this answer protocol message are described as follows:

Answerer-ID: This parameter uniquely identifies an answerer. By one approach this property persists even after the answer is propagated by intermediary questionees back to the original questioner. It is also possible, however, that an intermediary questionee will change this parametr to reflect itself (as may be appropriate in settings where the original questioner will not accept the answer if it bears the original answerer-ID).

Query-ID: This parameter identifies the query to which the answer is being sent. This parameter can be used when collating multiple responses at a questioner.

Question-propagation-list: This parameter comprises a list that identifies the set of questionees through which the query has propagated before reaching the answerer. In many cases this will be the same as the backwards-questionee-list as was received with the query. Each element of the list will typically comprise a questionee-ID.

Forward-questionee-list: This list can be semantically similar to the forward-questionee-list described above with respect to the query message. This list, however, is meant to inform the further list of questionees through which the answer would propagate, and in a typical application setting there can be only a single questionee-ID per list, thus indicating that the answer can be forwarded to only a single entity (i.e., answers should not usually be forwarded or propagated to multiple entities).

Backward-questionee-list: This list is semantically similar to the backward-quesitonee-list parameter as was described above with respect to the query message. This list, however, is meant to inform the further list of questionees through which an answer has been propagated.

Associate-trust-factor: This field indicates the trust placed by the answerer on the particular answer. This field, accordingly, can be used when making decisions regarding answer collation and propagation.

Co-relation-ID: The above-described co-relation-ID as was received in the query is echoed back in the answer to facilitate demonstrating to the questioner that the answerer indeed received the question through the user's social network.

Answer-list: This parameter contains the answers that are being sent by the answerer. This parameter contains the sub-parameter Answers. This sub-parameter comprises a field that contains the answer to a single question in its entirety and itself is comprised of a question-ID field, an application-usage field, an associate-trust-factor field, and an application-specific-answer-format field. The question-ID field identifies the particular question within the query to which this answer corresponds. The application-usage field is semantically similar to the corresponding field in the question message. The associate-trust-factor field associates each answer with a specific trust factor that the answerer provides. And the application-specific-answer-format field comprises a field that contains an application specific answer template. The answer can be embedded in this template to facilitate uniform and relatively straightforward user/automata comprehension and/or presentation.

By one approach, some or even all of the application usages of the query framework can have a corresponding application specific question-answer template. Such a template can be used for carrying the specific questions and answers relevant to that particular application. A given question-answer template will preferably be well suited to capture information that is relevant to a specific application usage, can serve to at least limit changes with respect to questions and answers by intermediaries, and can allow for extensions to the basic template to thereby accommodate minor variations as pertain to a current application.

Some illustrative examples in these regards will now be presented. These examples presume that the application at hand comprises a push-to-ask application intended for use by a younger demographic to support such activities as, “going out with friends,” “dating,” “obtaining information about friends,” and so forth. Those skilled in the art will recognize and understand that these presumptions and examples are not intended to comprise an exhaustive presentation and are offered only as illustrative examples of what is possible via these teachings. With that in mind, the following example comprises a combined question-answer template. A combined template, in turn, provides an ability to store answers and questions together and may also facilitate merging when such functionality is desired.

A first category to consider comprises questions having selectable answers. In this case, the questioner wishes to associate some answers with a given question with an expectation that an answerer will select from amongst the proffered candidate answers. As one simple example, the possible answers of “yes” and “no” can be provided for a question such as, “Would you care to join me at the theater?” As another example, a list of five antique shop names may be provided along with the question, “Which of these offers the best deal?” In this example a question template can be registered having the namespace “question-answer+xml/question/multiple-answer-choice”. A corresponding XML schematic could appear as follows:

```
<QuestionWithMultipleChoiceAnswer>
    <Question> this would contain the actual Question, which
    may be in any existing formats like HTML or VXML etc.
    </Question>
    <Answer>
        </Choices> this would contain the suitable choices
        which  are  applicable  for  the  current  Question.
        Again, it might be rendered in suitable formats like
        HTML or VXML.
        </Choices>
        <ChosenAnswer> this would contain the Answer, which
        was selected by the Answerer
        </ChosenAnswer>
    </Answer>
</QuestionWithMultipleChoiceAnswer>
```

A second category to consider comprises questions having likely answers that are constrained to a particular range. For example, a question dealing with the price of a particular object might with to constrain answers regarding that price to a range of possible prices that is bounded by a low price and a high price. In this example a question template can be registered having the namespace “question-answer+xml/question/range-limited-answer-choice”. A corresponding XML schematic could appear as follows:

```
<QuestionWithAnswersWithinARange>
    <Question> this would contain the actual Question, which
    may be in any existing formats like HTML or VXML etc.
    </Question>
    <Answer>
        </Upper-Range> this limits the upper range of the
        allowed answer. It may use existing representation
        formats like HTML or VXML.
        </Upper-Range>
        </Lower-Range> this limits the lower range of the
        allowed answer. It may use existing representation
        formats like HTML or VXML.
        </Lower-Range>
        <ChosenAnswer> this would contain the Answer, which
        was entered by the Answerer
        </ChosenAnswer>
    </Answer>
</QuestionWithAnswersWithinARange>
```

A third category to consider comprises questions having likely answers that are expressed using free-flowing string formats. Such a question is not limited with respect to format or range. In this example a question template can be registered having the namespace “question-answer+xml/question/free-format-answer”. A corresponding XML schematic could appear as follows:

```
<QuestionWithFreeFormatAnswer>
    <Question> this would contain the actual Question, which
    may be in any existing formats like HTML or VXML etc.
    </Question>
    <Answer>
        <ChosenAnswer> this would contain the Answer, which
        was entered by the Answerer
        </ChosenAnswer>
    </Answer>
</QuestionWithFreeFormatAnswer>
```

Yet another category to consider comprises embedding an existing question format within some other format. For example, it is possible that in a question having multiple choice answers, a different question is asked based on a particular choice that is selected by the answerer. A corresponding XML schematic could appear as follows:

```
<QuestionWithMultipleChoiceAnswer>
    <Question> this would contain the actual Question, which
    may be in any existing formats like HTML or VXML etc.
    </Question>
    <Answer>
        </Choices>
            <Choice1> “Yes”
                <Question> this embedded question can be
                any of the basic Questions defined above.
                </Question>
            </Choice1>
        </Choices>
        <ChosenAnswer> this would contain the Answer, which
        was selected by the Answerer
        </ChosenAnswer>
    </Answer>
</QuestionWithMultipleChoiceAnswer>
```

In some cases a question may be rendered to a user via HTML. An automated process to answer such a question would need to understand the HTML in order to facilitate providing an answer. An associated rendering with the question can be “application+push-to-ask/question/html”. A corresponding XML schematic could appear as follows (where content in bold font comprise HTML content):

```
<QuestionWithMultipleChoiceAnswer>
    <Question rendering=”html”>
        <LABEL>which is a better shop for antiques</LABEL>
    </Question>
    <Answer>
        </Choices rendering=”html”>
            <select name=“.pw_q”id=“pwq”>
            <Choice number=1 rendering=”html”>
                <option value=“ABC Antiques” >ABC Antiques
            </Choice>
            <Choice number=2 rendering=”html”>
                <option value=“XYZ Antiques” >XYZ Antiques
        </Choice>
        </select>
        </Choices>
    </Answer>
</QuestionWithMultipleChoiceAnswer>
```

In this next example, a sample question-answer template message is shown wherein the question is rendered to the user using voice XML (VXML). In some cases it may be appropriate or necessary for an automated mechanism to respond to the question and in such a case that mechanism must understand the VXML and the question string itself. An associated rendering with the question can be “application+push-to-ask/question/vxml”. In the following example, VXML represents a question having multiple choice answers and bold font serves to identify the VXML content:

```
<QuestionWithMultipleChoiceAnswer>
    <Question rendering=”vxml”>
        <prompt> Which is a better shop for Antiques
        <enumerate/>
        </prompt>
    </Question>
    <Answer>
        </Choices rendering=”vxml”>
            <Choice number=1 rendering=”vxml”>
                <choice next=“#ABCAntiques”>ABC
                Antiques</choice>
            </Choice>
            <Choice number=2 rendering=”vxml”>
                <choice next=“#XYZAntiques”>XYZ
                Antiques</choice>
            </Choice>
            </select>
        </Choices>
    </Answer>
</QuestionWithMultipleChoiceAnswer>
```

In the above HTML and VXML representations, the interleaving between the question-answer template and the actual HTMLVXML scripts aids with respect to defining a common representation of the question-answer template. This, in turn, helps facilitate efficient parsing and collating of the questions and answers. Those skilled in the art will recognize that, if desired, a pure HTML or VXML script could be employed without using a template. In such a case, however, any collation mechanism for answers would likely need to be written specifically for HTML or VXML separately.

As noted above the push-to-ask protocol layer can work in conjunction with any of a variety of transport protocols. For many purposes, however, session initiation protocol probably stands as a particularly useful alternative in this respect. Session initiation protocol, for example, is already a standard accepted protocol for push-to-talk applications. A push-to-ask-based extension therefore poses little technical difficulty. Session initiation protocol also offers an ability to reach a person as versus merely a platform. This, in turn, would help in reaching a particular intended social contact, wherever they might be.

Session initiation protocol also has well defined headers that can well accommodate the push-to-ask concepts set forth herein (this includes, for example, an ability to indicate a reason for a request, support for multiple message bodies, an ability to track the route through which a message has been forwarded, and an ability to indicate whether propagation of the message should pass through a given node). In addition, session initiation protocol has a concept of “session” that can be re-used in scenarios where there are multiple question/answer exchanges for a same purpose or where there are multi-level question/answer exchanges. And, as yet one more advantage in this regard, session initiation protocol already supports use of a header that can limit the maximum number of nodes to which the message can travel.

Notwithstanding these inherent benefits, session initiation protocol can be modified slightly to better accommodate at least certain aspects of these teachings. By one approach, then, these teachings support the introduction and use of two new session initiation protocol messages; QUESTION and ANSWER.

A push-to-ask question message could be carried in a QUESTION message. Such an approach could look like the following:

QUESTION sip:john@abc.com SIP/2.0
Via: ...
Max-Forwards: 70
To: John <sip.john@abc.com>
From: <sip:alice@atlanta.com>;tag=192
Contact: <Sip:alice@pc.home.com >
Content-Type: application/question+xml
Content-Length: 142
Call-ID: a84b4c76e66710
CSeq: 123 QUESTION
<Question Message Body>

The headers could, of course, employ the same semantics as are used in core session initiation protocol practices. The “to” in the message presented above points towards an intended recipient of the question. It may be populated with the AOR uniform resource indicator of the questionee or it might be populated with a globally routable user agent uniform resource indicator in cases where the question is directed towards a specific device (or contact) of a user rather than the user personally. The “from” serves to identify the questioner user agent who initiates the QUESTION message.

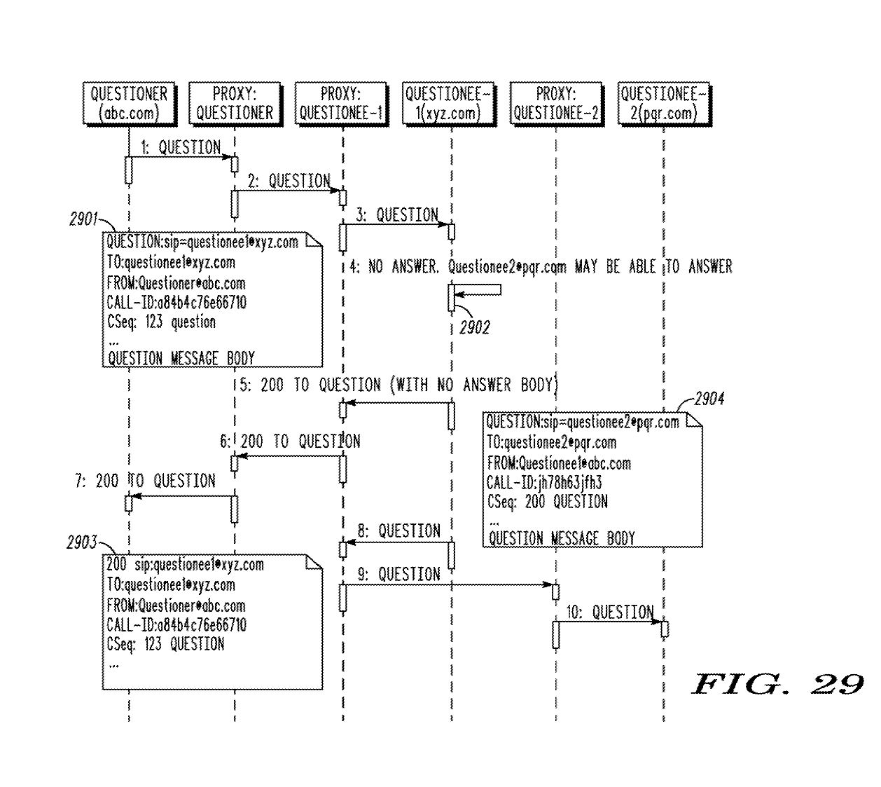

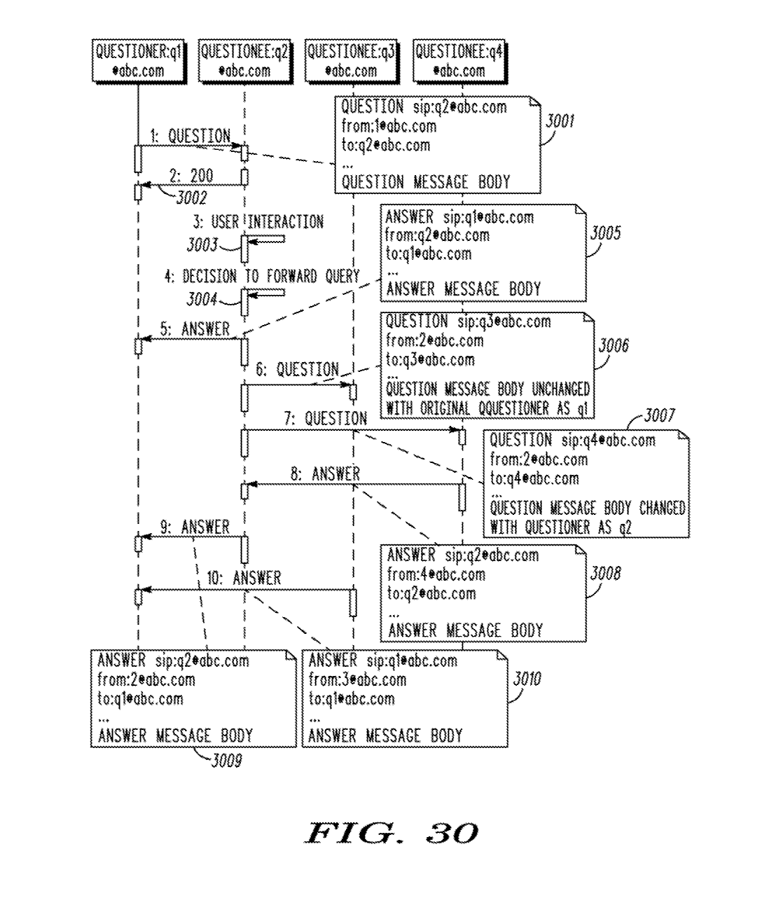

The call flow diagram presented in FIG. 29 illustrates usage of a QUESTION message. An original query is transported from a questioner to a first questionee using a corresponding QUESTION message 2901. In this example the first questionee determines 2902 that it cannot provide an adequate response and replies with a session initiation protocol 200 message 2903 as is known in the art. This first questionee, in this example, also propagates the query in a new QUESTION message 2904 to a second questionee. In this example the “from” and “to” fields have been changed in this second QUESTION message 2904 by the first questionee to reflect the new sourcing and receiving entities.

In a somewhat analogous manner a push-to-ask answer may be carried in a session initiation protocol ANSWER message. Such a message can appear as follows:

ANSWER sip:alice@atlanta.com SIP/2.0
Via: ...
Max-Forwards: 70
To: Alice <sip:alice@atlanta.com>
From: <sip:john@abc.com>;tag=192
Contact: <sip:john@pc.abc.com >
Content-Type: application/answer+xml
Content-Length: 142
Call-ID: a84b4c76e66872
CSeq: 124 ANSWER
<Answer Message Body>

As before, the session initiation protocol headers may have the same functionality as comports with core session initiation protocol methodologies. In this case, the “to” header points toward the intended recipient of the ANSWER message which may be the original questioner or an intermediary questionee that identified itself as the expected recipient when propagating the original question. The “from” header in turn indicates the identity of the entity that is either answering the question or propagating the answer towards the questioner.

The call flow diagram presented in FIG. 30 illustrates usage of an ANSWER message. In this example a questioner sends a QUESTION message 3001 as described above to a first questionee. The “from” header identifies the questioner and the “to” header identifies the first questionee. In this example some user interaction is required as the first questionee and the first questionee therefore responds at this time with a session initiation protocol 200 message 3002. While the first questionee engages in a user interaction session 3003, the questionee also decides 3004 to forward the question to other questionees who might be able to provide a useful answer. The first questionee then provides its answer to the question in an ANSWER message 3005 that identifies the questioner in the “to” header and the first questionee in the “from” header.

In accordance with the decision 3004 to further propagate the question, the first questionee sends a QUESTION message 3006 to a second questionee and another QUESTION message 3007 to a third questionee. In both cases the “from” header identifies the first questionee and the recipient questionee is identified in the “to” header. Note, however, that the push-to-ask message for the second questionee is not changed (as compared to the original question); as a result, the second questionee provides its eventual ANSWER message 3010 directly to the questioner and not via the first questionee.

Conversely, the push-to-ask message for the third questionee has been changed by the first questionee. This change in particular now identifies the first questionee as being the proper recipient of any answer that the third questionee might provide. As a result, the third questionee provides its ANSWER message 3008 to the first questionee and the first questionee then propagates a corresponding ANSWER message 3009 to the questioner.

So configured, it will be seen and understood that a push-to-ask capability can be readily supported using any of a wide variety of end user applications and transport mechanisms. Social networks are readily leveraged while simultaneously tending to encourage or require the promulgation of “good” answers. Such benefits are achieved regardless of whether questioners and ultimate answerers have or do not have a pre-established relationship. These teachings permit great control and latitude with respect to how far a given question may propagate and the time frame within which a response might be yielded. As a result, individuals can now employ a relatively convenient and even reasonably intuitive mechanism to seek answers to virtually any question in a manner that is likely to yield answers that are useful to that party.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. XX, an illustrative approach to such a platform will now be provided.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
providing a push-to-ask protocol layer comprising:
a question receiving function;
an answer receiving function;
a trust management function; and
a propagation function that is configured and arranged to determine propagation of content comprising at least one of:
a question as is provided by the question receiving function; and
an answer as is provided by the answer receiving function;
as a function, at least in part, of trust information as is provided by the trust management function;
using the push-to-ask protocol layer to facilitate automated dissemination of a question as provided via a push-to-ask application to a social network as corresponds to a user of that push-to-ask application and to facilitate a return of at least one corresponding answer to that push-to-ask application.

2. The method of claim 1 wherein providing the push-to-ask protocol layer comprises providing the push-to-ask protocol layer using an end device host.

3. The method of claim 1 wherein providing the push-to-ask protocol layer comprises providing the push-to-ask protocol layer using a network server host.

4. The method of claim 1 wherein providing a push-to-ask protocol layer further comprises providing a question and answer message generation function that is configured and arranged to:
generate disseminable questions based, at least in part, upon question content as is provided by the question receiving function;
generate answers to received questions.

5. The method of claim 1 wherein the trust management function is further configured and arranged to maintain trust information for at least some potential recipients of a question.

6. The method of claim 5 wherein the trust management function is further configured and arranged to use the trust information to facilitate determining how appropriate it may be to disseminate a given question to a given candidate recipient.

7. The method of claim 5 wherein the trust management function is further configured and arranged to use the trust information to facilitate splitting a question into a plurality of sub-questions and then determining how appropriate it may be to disseminate a given sub-question to a given candidate recipient.

8. The method of claim 5 wherein the trust management function is further configured and arranged to facilitate a dynamic run-time establishment of trust as between an answering entity and the user when the answering entity does not comprise a part of the social network as corresponds to the user of the push-to-ask application.

9. The method of claim 1 wherein the propagation function is configured and arranged to determine propagation by, at least in part:
not propagating the content upon determining that subsequent propagation is unnecessary; and
propagating the content upon determining that subsequent propagation is necessary.

10. The method of claim 1 wherein the propagation function is configured and arranged to facilitate the propagation of sub-questions as are formed by splitting a question as a function, at least in part, of the trust management function.

11. The method of claim 1 wherein the propagation function is configured and arranged to facilitate the propagation of a question to additional recipients subsequent to having already propagated that question to at least one previous recipient.

12. The method of claim 11 wherein the propagation function is configured and arranged to facilitate the propagation of a question to additional recipients subsequent to having already propagated that question to at least one previous recipient upon having determined that the at least one previous recipient provided an unacceptable response.

13. The method of claim 1 wherein using the push-to-ask protocol layer comprises:
using the push-to-ask protocol layer to facilitate the automated dissemination of a question as provided via a push-to-ask application to a social network using a Session Initiation Protocol-compatible message;
using the push-to-ask protocol layer to facilitate the return of at least one corresponding answer to that push-to-ask application using a Session Initiation Protocol-compatible message.

14. The method of claim 1 wherein the propagation function is further configured and arranged to determine propagation of content comprising at least one of:
a question as is provided by the question receiving function; and
an answer as is provided by the answer receiving function;
as a function, at least in part, of a predetermined maximum number of entities through which the content is allowed to be propagated.

15. The method of claim 1 wherein the propagation function is further configured and arranged to determine propagation of content comprising at least one of:
a question as is provided by the question receiving function; and
an answer as is provided by the answer receiving function;
as a function, at least in part, of a predetermined maximum number of entities to which the content is allowed to be propagated.

16. The method of claim 1 wherein the propagation function is further configured and arranged to determine propagation of content comprising at least one of:
a question as is provided by the question receiving function; and
an answer as is provided by the answer receiving function;
as a function, at least in part, of a predetermined time by when an answer is to be provided to the question.

17. The method of claim 1 wherein providing a push-to-ask protocol layer further comprises providing a push-to-ask protocol layer comprising:
a retransmission function that is configured and arranged to determine when to retransmit a question that has already been transmitted.

18. The method of claim 17 wherein the retransmission function is configured and arranged to determine when to retransmit a question as a function, at least in part, of answer quality as has been provided in response to an earlier transmission of the question.

19. The method of claim 1 wherein using the push-to-ask protocol layer further comprises using a push-to-ask protocol layer template to form a message that contains the content and then propagating the message.

20. An apparatus comprising:
a processing platform having a push-to-ask protocol layer stored therein wherein the push-to-ask protocol layer comprises:
a question receiving function;
an answer receiving function;
a trust management function; and
a propagation function that is configured and arranged to determine propagation of content comprising at least one of:
a question as is provided by the question receiving function; and
an answer as is provided by the answer receiving function;
as a function, at least in part, of trust information as is provided by the trust management function;
such that the push-to-ask protocol layer facilitates automated dissemination of a question as provided via a push-to-ask application to a social network as corresponds to a user of that push-to-ask application and to facilitate a return of at least one corresponding answer to that push-to-ask application.
